(19) United States
(12) Patent Application Publication
(10) Pub. No.: US 2025/0363593 A1
(43) Pub. Date: Nov. 27, 2025

(54) Adaptive Real Time Image and Video Processing Using PCM-Enhanced Visual Strategy Caching and Multi-Stage Cognitive Routing

(71) Applicant: AtomBeam Technologies Inc., Moraga, CA (US)

(72) Inventors: Zhu Li, Overland Park, KS (US); Paras Maharjan, Kansas City, MO (US)

(21) Appl. No.: 19/295,887

(22) Filed: Aug. 11, 2025

Related U.S. Application Data
(63) Continuation-in-part of application No. 19/051,193, filed on Feb. 12, 2025, now Pat. No. 12,387,050.
(63) Continuation-in-part of application No. 18/961,463, filed on Nov. 27, 2024, now Pat. No. 12,437,365.
Application No. 18/961,463 is a continuation-in-part of application No. 18/596,677, filed on Mar. 6, 2024, now Pat. No. 12,198,304.
(60) Provisional application No. 63/847,889, filed on Jul. 21, 2025.

(51) Int. Cl. G06T 5/10; G06T 7/00

(52) U.S. Cl. CPC G06T 5/10; G06T 7/0002; G06T 2207/20052; G06T 2207/20064; G06T 2207/20084

(57) ABSTRACT

A system and method for adaptive image and video processing using a Persistent Cognitive Machine (PCM) architecture with visual strategy caching. The system receives degraded input media and extracts degradation fingerprints to query a PCM-based visual strategy cache containing previously successful processing strategies. When matching cached strategies are found above a relevance threshold, they are retrieved and applied directly. When no match exists, the input is processed through transform-domain networks to generate new strategies. A pattern synthesizer combines multiple strategies for complex degradation types. The system evaluates processing effectiveness using a feedback controller and stores successful strategies in the hierarchical cache. This cognitive approach enables real-time processing with continuously improving performance as the cache learns from successful patterns. The adaptive architecture eliminates redundant processing while maintaining high-quality output, making it suitable for diverse imaging and video applications requiring efficient enhancement capabilities with superior performance over traditional methods.

### CROSS-REFERENCE TO RELATED APPLICATIONS

Priority is claimed in the application data sheet to the following patents or patent applications, each of which is expressly incorporated herein by reference in its entirety:
63/847,889
Ser. No. 19/051,193
Ser. No. 18/961,463
Ser. No. 18/596,677

### BACKGROUND OF THE INVENTION

### Field of the Art

The present invention is in the field of cognitive visual processing, and more particularly adaptive image and video enhancement systems that employ structured latent manifolds, visual strategy caching, and geometric cognition principles derived from Persistent Cognitive Machine (PCM) architectures.

### Discussion of the State of the Art

Image deblurring is a classical low-level vision task of enhancing and improving the quality of an image by removing blurring artifacts that are caused by factors such as camera motion, object motion, missed focus, insufficient depth of field, or lens softness. Blur in an image is unavoidable, but can be minimized using good quality sensors and post processing methods. In smartphone cameras, image blur is common and noticeable because of the compact form factor lens and imagine sensor used in smartphones. Image deblurring is an essential step in improving image and video systems which in turn increases the quality of image reproduction, ultimately leading to better visual perception.

Modern processing techniques can be divided into two major categories: spatial domain processing and transform domain processing. Out of the two major categories, spatial domain processing is more commonly used and generally pertains to processing in either RGB color space or in the raw sensor space. The process involves manipulating or enhancing an image by working directly with an image's pixel values. Even earlier methods such as inverse filtering and Wiener filtering try to deblur images by converting into a frequency domain, provided the degradation of the image is from a known global blur kernel. Very few methods employ transform domain processing that usually decomposes an image into subband images and then performs processing in the transform domain.

Most conventional methods rely on the energy optimization approach to jointly estimate the blur kernel and latent sharp image from a single blurry image. The energy optimization approach refers to techniques that minimize an energy function associated with an image. The approach may be applied to a variety of image processing methods, including image deblurring. These methods assume that a scene is static and that any blur is caused by camera motion only. Some recent methods for dynamic scenes assume that blur in an image is caused by both camera motion and object motion. Blind motion deblurring further assumes that blur in an image is non-uniformly distributed and performs image deblurring by segmenting the image into regions with different blurs and uses a box filter to restore a sharp image.

Recent advancements in deep learning and the availability of realistic, real world datasets has spurred the development of using convolutional neural networks (CNNs) for image deblurring. Multiscale CNNs use coarse to fine architecture to gradually restore a sharp image on different resolutions in a pyramid. Generally, CNNs are used in tandem with spatial domain processing to produce a restored image.

The issue with currently used image deblurring methods is that they are highly sensitive to noise and fail to restore images when subjective to real world scenarios. Additionally, image and video processing needs to be done after footage or an image is taken in post-production processing. This increases the amount of time and effort it takes to produce high quality videos and images.

What is needed is a system and method for real time video and image processing that not only leverages discrete cosine transform (DCT) and neural network techniques but also incorporates a persistent cognitive memory framework for adaptive strategy management. Existing solutions lack the ability to contextually recall, synthesize, and refine processing strategies based on previously encountered degradation patterns. A system is needed that integrates intelligent routing, hierarchical memory, and symbolic reasoning-such as those enabled by a Persistent Cognitive Machine (PCM)-to dynamically select or generate high-performance visual strategies tailored to current image conditions. Such a system would reduce latency, improve processing efficiency, and enhance output quality in complex, real-world environments where multiple degradation types may occur simultaneously.

### SUMMARY OF THE INVENTION

Accordingly, the inventor has conceived and reduced to practice, a system and method for adaptive real time discrete cosine transform image and video processing with cognitive visual strategy caching and latent geometric memory. The system incorporates transform-domain image processing with convolutional neural networks (CNNs) to achieve fast, efficient, and accurate visual enhancement. Unlike conventional CNNs applied in the spatial domain, the present system applies neural networks in the transform domain—specifically over DCT-generated subband images—yielding superior results, especially for real-world degradations such as motion blue, compression artifacts, and defocus. Furthermore, the system includes a Persistent Cognitive Machine (PCM)-based visual strategy cache, which allows adaptive reuse and synthesis of image restoration strategies based on previously encountered degradation profiles. This memory-driven architecture enables low-latency, single-pass image processing through a linear and self-optimizing pipeline.

Studies show that the proposed system and method maintain significantly higher Peak Signal-to-Noise Ratio (PSNR) than other visual processing pipelines. The system performs robustly under both ensembled and non-ensembled configurations of its neural networks. In ensemble mode, the system synthesizes strategy outputs across multiple DCT subbands using pattern synthesis networks, which may dynamically adjust their contribution weights based on degradation severity and type. When operating in non-ensembled mode, individual DCT Deblur networks (AC and DC) still outperform comparable spatial-domain models. In both cases, performance is further improved by using a PCM Thought Cache, which indexes degradation fingerprints as latent geodesic trajectories—compressible, traversable representations of visual “thoughts” grounded in Lorentzian latent geometry.

According to a preferred embodiment, a computer system comprising: a hardware memory, wherein the computer system is configured to execute software instructions stored on non-transitory machine-readable storage media that: receive a degraded image or video frame for processing; analyze the degraded input using a strategy router to determine degradation characteristics; query a PCM visual strategy cache to identify previously successful processing strategies for similar degradation patterns; determine whether cached strategies exist that match the identified degradation characteristics above a relevance threshold; route the degraded input through a DCT block when no matching cached strategies are found; retrieve one or more cached visual strategies when matching strategies are found above the threshold; synthesize multiple retrieved strategies using the pattern synthesizer when the degradation characteristics indicate combined degradation types; process the degraded input using either the retrieved strategies or DCT-generated parameters through DCT deblur networks; evaluate processing effectiveness using a cache feedback controller to determine quality metrics and compression pressure; and store successful processing strategies in the PCM cache with associated degradation fingerprints and geodesic metadata, is disclosed.

According to another preferred embodiment, a method for real-time discrete cosine transform image and video processing with convolutional neural network architecture comprises the steps of: receiving a degraded image or video frame for processing; analyzing the degraded input using a strategy router to determine degradation characteristics; querying a PCM-based visual strategy cache to identify previously successful processing strategies for similar degradation patterns; determining whether cached strategies exist that match the identified degradation characteristics above a relevance threshold; routing the degraded input through a DCT block when no matching cached strategies are found; retrieving one or more cached visual strategies when matching strategies are found above the threshold; synthesizing multiple retrieved strategies using a pattern synthesizer when the degradation characteristics indicate combined degradation types; processing the degraded input using either the retrieved strategies or DCT-generated parameters through DCT deblur networks; evaluating processing effectiveness using a cache feedback controller to determine quality metrics and compression pressure; and storing successful processing strategies in the visual strategy cache with associated degradation fingerprints, symbolic anchors, and latent geodesics.

According to an aspect of an embodiment, the DCT Deblur Network system further comprises a convolutional neural network for transform-domain deblurring across frequency bands.

According to an aspect of an embodiment, the DCT Block transforms the degraded image by using a 4×4 Discrete Cosine Transform function.

According to an aspect of an embodiment, the processing networks comprise convolutional neural network (CNN) architectures.

According to an aspect of an embodiment, DCT block creates a plurality of subband images, each corresponding to either high-energy (AC) or low-energy (DC) components.

According to an aspect of an embodiment, a loss function may be used to compute transform-domain loss across channels, and may further incorporate geodesic regularization to preserve latent structure.

According to an aspect of an embodiment, an adaptive blur and artifact classification module that processes the plurality of subband images into a plurality of identified degradations.

According to an aspect of an embodiment, an adaptive blur and artifact classification module processes the subband images to identify and categorize degradation types.

According to an aspect of an embodiment, the adaptive classification module dynamically adjusts the parameters of the DCT Deblur Network channels according to the identified degradations.

According to an aspect of an embodiment, the pattern synthesizer comprises a weight calculator and a strategy merger for combining multiple cached strategies through weighted geodesic averaging in the Lorentzian latent space.

According to an aspect of an embodiment, the degradation characteristics include one or more of motion blur, defocus blur, compression artifacts, and noise patterns.

According to an aspect of an embodiment, the adaptive classification module is trained using a database of degradation fingerprints and associated latent geodesic representations, allowing it to recognize, tag, and retrieve symbolic anchors embedded within the PCM memory

### BRIEF DESCRIPTION OF THE DRAWING FIGURES

FIG. 1 is a block diagram illustrating an exemplary system architecture for real time discrete cosine transform image and video processing with convolutional neural network architecture, according to an embodiment.

FIG. 2 is a block diagram illustrating an exemplary architecture for a subsystem of the system for real time discrete cosine transform image and video processing with convolutional neural network architecture, a DCT Deblur Network system.

FIG. 3 is a block diagram illustrating an exemplary architecture for a component of the DCT Deblur Network subsystem, a ResBlock.

FIG. 4 is a diagram showing an embodiment of one aspect of the real time discrete cosine transform image and video processing with convolutional neural network architecture system, specifically, the DCT Block Output, more specifically, subband images.

FIG. 5 is a diagram showing an embodiment where the subband images are comprised of three-color components each further comprising an AC component and a DC component.

FIG. 6 is a flow diagram illustrating an exemplary method for image and video deconstruction, according to an embodiment.

FIG. 7 is a flow diagram illustrating an exemplary method for image and video reconstruction, according to an embodiment.

FIG. 8 is a block diagram illustrating an exemplary aspect of a system for image processing using a convolutional neural network, the DCT Deblur Network system.

FIG. 9 is a block diagram illustrating an exemplary system architecture for adaptive real time discrete cosine transform image and video processing with convolutional neural network architecture, according to an embodiment.

FIG. 10 is a block diagram illustrating an exemplary architecture for a subsystem of the system for adaptive real time discrete cosine transform image and video processing with convolutional neural network architecture, an adaptive blur and artifact classification module.

FIG. 11 is a block diagram illustrating an exemplary architecture for a subsystem of the system for adaptive real time discrete cosine transform image and video processing with convolutional neural network architecture, a machine learning training subsystem.

FIG. 12 is a flow diagram illustrating an exemplary method for adaptive real time discrete cosine transform image and video processing with convolutional neural network architecture, according to an embodiment.

FIG. 13 is a flow diagram illustrating an exemplary method for training an adaptive blur and artifact classification module.

FIG. 14 is a block diagram illustrating an exemplary system architecture for adaptive real time discrete cosine transform image and video processing with convolutional neural network architecture enhanced with visual strategy caching capabilities.

FIG. 15 is a block diagram illustrating an exemplary component for adaptive real time discrete cosine transform image and video processing with convolutional neural network architecture, the router and supervisor.

FIG. 16 is a block diagram illustrating an exemplary architecture for a visual strategy cache that implements a hierarchical memory system for storing and managing image processing strategies.

FIG. 17 is a block diagram illustrating an exemplary architecture for a pattern synthesizer enables intelligent combination of multiple visual processing strategies to address complex image degradations.

FIG. 18 is a flow diagram illustrating an exemplary method for adaptive real time discrete cosine transform image and video processing with convolutional neural network architecture using visual strategy caching.

FIG. 19 is a flow diagram illustrating an exemplary method for visual strategy synthesis and application in adaptive image processing.

FIG. 20 is a flow diagram illustrating an exemplary method for cache-based visual processing optimization.

FIG. 21 is a block diagram illustrating an exemplary system architecture for a multi-state LLM with unlimited context.

FIG. 22 is a block diagram illustrating an exemplary system architecture for a multi-state LLM with unlimited context with thought synthesis and retrieval.

FIG. 23 is a block diagram illustrating an exemplary system architecture for a multi-state LLM with unlimited context with local and global thought caches.

FIG. 24 is a block diagram illustrating exemplary components for a multi-state LLM with unlimited context, a router and a controller.

FIG. 25 is a block diagram illustrating an exemplary system architecture of a thought cache that has both a long-term memory and a short-term memory.

FIG. 26 is a block diagram illustrating an exemplary system architecture for PCM-integrated real-time image and video processing.

FIG. 27 is a block diagram of an exemplary architecture for a hierarchical visual strategy cache system designed according to Persistent Cognitive Machine (PCM) memory principles.

FIG. 28 is a flow diagram representing an exemplary method for adaptive image and video processing within a system that implements a hierarchical visual strategy cache integrated into a Persistent Cognitive Machine (PCM) architecture.

FIG. 29 illustrates an exemplary computing environment on which an embodiment described herein may be implemented, in full or in part.

### DETAILED DESCRIPTION OF THE INVENTION

The inventor has conceived, and reduced to practice, a system and method for adaptive real time discrete cosine transform image and video processing with cognitive visual strategy caching. The system for adaptive real-image and video processing may be implemented within a Persistent Cognitive Machine (PCM) framework as described in parent application and incorporated by reference in its entirety. The PCM enables the system to maintain and retrieve visual processing strategies in a hierarchical memory structure comprising session-specific short-term memory and validated long-term memory. Degradation fingerprints extracted from input images may function as prompt analogs, allowing the strategy router to query the PCM's thought cache for high-confidence visual strategies or strategy components. When multiple degradation types are detected, the system may invoke a PCM-based pattern synthesizer to interpolate across related cached strategies—each represented as a symbolic or geodesic trajectory—based on Lorentzian latent embedding. These synthesized strategies are then used to configure DCT deblur network in a targeted and computationally efficient manner.

The Persistent Cognitive Machine (PCM) architecture represents a unified cognitive processing framework that applies consistent memory management, strategy synthesis, and adaptive learning principles across multiple domains. The PCM framework operates on the principle that both visual processing strategies and linguistic reasoning patterns can be represented as structured knowledge objects in a shared latent space, enabling cross-modal learning and strategy transfer.

In the PCM framework, all processing strategies—whether for image deblurring, language understanding, or other cognitive tasks—are encoded as latent trajectories in a common geometric space. This unified representation enables the system to apply successful patterns from one domain to related problems in another domain. For example, edge detection strategies learned in visual processing may inform boundary detection in natural language parsing.

The PCM implements a hierarchical cognitive memory system with three primary components: (1) a universal strategy encoder that converts domain-specific processing methods into standardized latent representations; (2) a cross-modal similarity engine that identifies analogous patterns across different processing domains; and (3) an adaptive synthesis mechanism that combines strategies from multiple domains to solve complex, multi-modal problems.

The PCM framework implements a distributed memory architecture comprising a hybrid in-memory and persistent storage design. Visual strategies are stored as key-value pairs within a distributed hash table (DHT), where the degradation fingerprint serves as a 256-bit SHA-3-derived hash key, and the corresponding strategy is stored as a compressed binary object in MessagePack or CBOR format. Memory allocation across short-term and long-term cache layers is handled using a two-tier policy: (1) a least-recently-used (LRU) ring buffer for high-speed short-term strategy recall; and (2) a persistent vector database—such as FAISS, Annoy, or ScaNN—for long-term storage and latent similarity querying. The PCM memory manager employs consistent hashing with virtual node partitioning to ensure uniform distribution across memory shards. Strategy metadata includes timestamps, symbolic anchors, usage frequency counters, confidence scores, and latent geodesic coordinates. An internal PCM API exposes retrieval, insertion, and eviction functions.

Moreover, the PCM's multi-state LLM may be employed to refine or generate new strategy hypotheses by evaluating the quality metrics (e.g., PSNR, SSIM) associated with previously stored strategies. This allows the system to operate as a self-optimizing, context-sensitive cognitive processor, improving performance over time and across degradation conditions.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

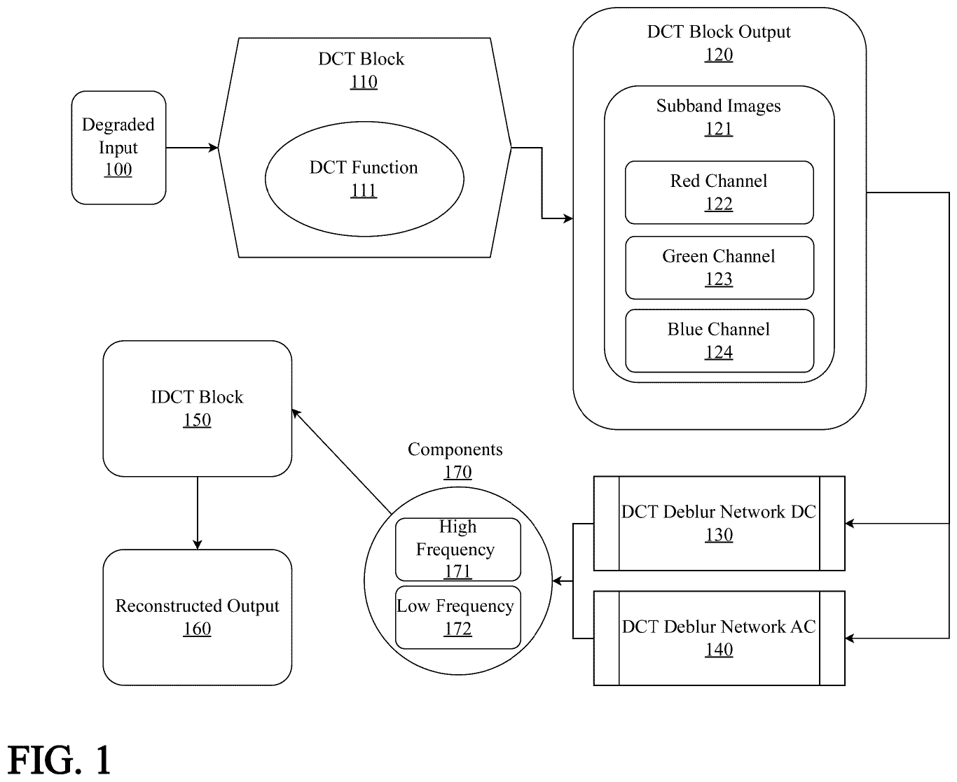

FIG. 1 is a block diagram illustrating an exemplary system architecture for real time discrete cosine transform image and video processing with convolutional neural network architecture, according to an embodiment. The system comprises a degraded input 100, a DCT block 110, a DCT block output 120, a DCT Deblur Network DC channel 130, a DCT Deblur Network AC channel 140, an IDCT block 150, and a reconstructed output 160.

In one embodiment, the degraded input 100 is passed through and transformed into a plurality of subband images by the DCT block 110 which may use a blockwise 4×4 Discrete Cosine Transform (DCT) function 111. A Discrete Cosine Transform function is not the only function that may be used in this process. For example, in one embodiment, the DCT block may use a wavelet transform function instead of a DCT function. The DCT output 120 in one embodiment may be a fraction of the degraded input's 100 resolution with a plurality of subband images 121 for a red 122, a green 123, and a blue 124 channel. The DCT output 120 may be passed through two transform domain deblurring networks, the DCT Deblur Network AC 140 and the DCT Deblur Network DC 130 channels—collectively referred to as the channels. In one embodiment, the channels use a parallel configuration to deblur the plurality of subband images separately for a plurality of high frequency components 171 and a plurality of low frequency components 172—collectively referred to as the components 170. The plurality of high frequency components 171 and the plurality of low frequency components 172 may be passed through an IDCT block 150 which may reconstruct the components using Inverse Discrete Cosine Transform. The IDCT block 150 uses the inverse of the function used in the DCT block 110. In one embodiment, the IDCT block 150 may use an inverse wavelet transform function. The components are reconstructed into a reconstructed output 160.

High frequency components 171 and low frequency components 172 are labeled high and low frequency because of the information they contain. The plurality of subband images may be comprised of a plurality of static images which represent the stationary portions of the degraded input 100 and a plurality of dynamic images which represent the dynamic, blurred portions of the degraded input 100. Static portions of the degraded image 100 are referred to as DC components. Dynamic portions of the degraded image 100 are referred to as AC components.

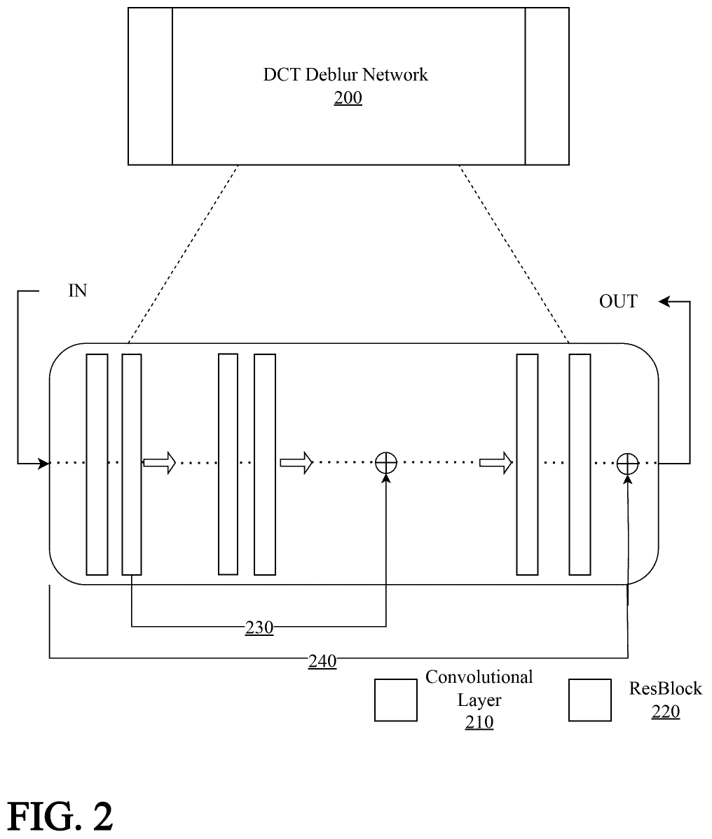

FIG. 2 is a block diagram illustrating an exemplary architecture for a subsystem of the system for real time discrete cosine transform image and video processing with convolutional neural network architecture, a DCT Deblut Network system comprising a DCT Deblur Network DC 130 channel and a DCT Deblur Network AC 140 channel. A DCT Deblur Network channel 200 may be comprised of a plurality of convolutional neural network functions including convolutional layers 210, a plurality of ResBlocks 220, and a plurality of connections which may include a sub-band specific pixel residue connection 240 and a feature-level skip connection 230.

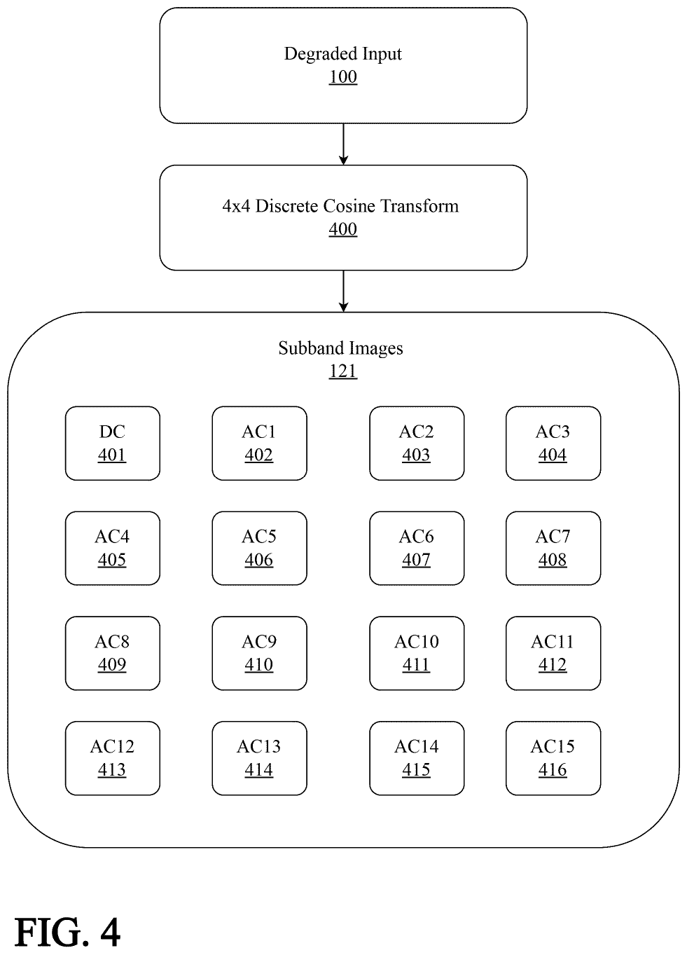

In one embodiment, high frequency components 171 and low frequency components 172 are passed through a respective DCT Deblur Network channel 200 by being input through an initial convolutional layer 210. After being input through the initial convolutional layer, the channels may be transformed by a series of convolutional layers 210 and ResBlocks 220 where the series comprises a sub-band specific pixel residue connection 240 and a feature-level skip connection 230. For the purposes of FIG. 4, convolutional layers 210 are shown by a solid white rectangle, as seen in the legend in the bottom of the figure. Likewise, ResBlocks 220 are shown by a rectangle filled with diagonal lines, as seen in the legend in the bottom of the figure.

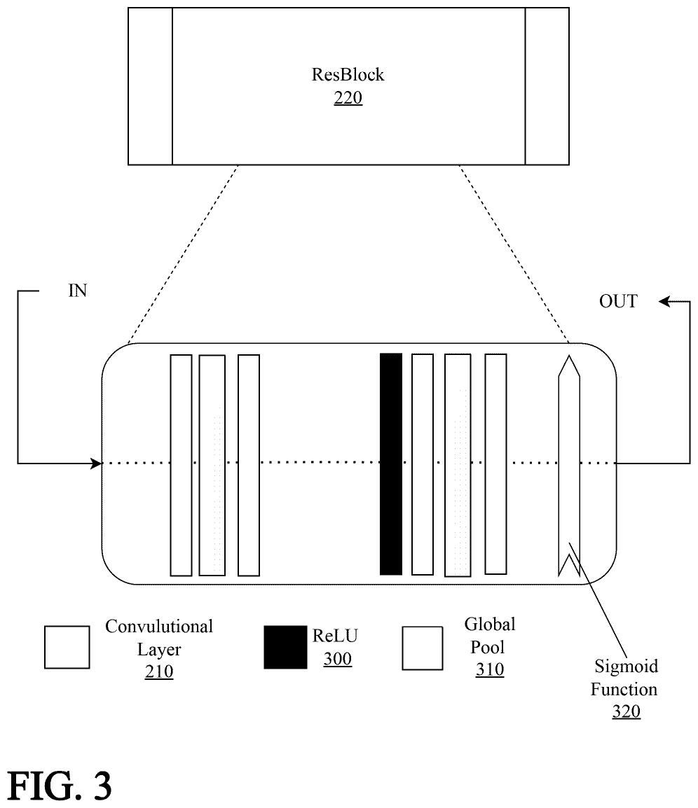

FIG. 3 is a block diagram illustrating an exemplary architecture for a component of the DCT Deblur Network subsystem, a ResBlock. A ResBlock may be further comprised of a plurality of convolutional layers 210, a plurality of Rectified Linear Units (ReLUs) 300, a plurality of Global Pooling layers 310, and a plurality of Sigmoid Functions 320. In one embodiment, a ResBlock 220 may be comprised of components in the following order: a convolutional layer 210, a ReLU layer 300, a convolutional layer 210, a ReLU layer 300, a convolutional layer 210, a global pooling layer 310, a convolutional layer 210, and a sigmoid function 320 where each layer may contain a plurality of its corresponding components. In FIG. 3, convolutional layers 210 are denoted by solid white rectangles, ReLU layers 300 are denoted by solid black rectangles, and global pooling layers 310 are denoted by grid line filled rectangles. In a typical embodiment, each of the proceeding components work in series to complete a ResBlock 220. The ResBlock 220 works in series with additional convolutional layers 210 in a DCT Deblur Network channel to process subband images 121.

FIG. 4 is a diagram showing an embodiment of one aspect of the real time discrete cosine transform image and video processing with convolutional neural network architecture system, specifically, the DCT Block Output 120, more specifically, the subband images. In one embodiment, a 4×4 Discrete Cosine Transform 400 is applied to the degraded input 100 which converts the degraded input 100 into 16 subband images for the red 122, the green 123, and the blue 124 channels. Each color channel may have a plurality of subband images 121 where a plurality of the subband images 121 will be low frequency (DC) images and a plurality of the subband images 121 will be high frequency (AC) images. In one embodiment, there may be one DC image and fifteen AC images. In the embodiment where there is one DC image and fifteen

AC images, the DC image 401 contains the most information about the degraded input 100. AC1 402 represents the primary vertical component of the degraded input 100, AC4 405 represents the primary horizontal components of the degraded input 100, and AC5 406 represents the primary diagonal component of the degraded input 100. AC1 402, AC4 405, and AC5 406 contain the second highest level of information behind DC 401. They collectively represent vertical, horizontal, and diagonal motion that causes blurring in the degraded input 100. The remaining AC subband images contain progressively less information in either the vertical, horizontal, or diagonal spaces of the degraded input 100. Breaking an imaging into small subband images 121 where each subband image 121 ranges from high levels of information to low levels of information allows for easier processing of each subband image. Additionally, because the principal components containing high levels of information about the degraded input 100 are known, more priority can be given to those subband images (DC 401, AC1 402, AC4 405, AC5 406) during image processing.

In one embodiment, a degradation fingerprint is extracted using a multi-stage visual analysis pipeline. The system first applies Sobel edge detection using 3×3 convolutional kernels to generate edge maps along horizontal and vertical directions. These are used to estimate edge sharpness and directionality. Next, local image patches (e.g., 8×8, 32×32) are analyzed using Fast Fourier Transform (FFT) to obtain power spectral density (PSD) distributions. The system then computes statistical moments (mean, variance, skewness, and kurtosis) across each patch's spectral response to assess degradation intensity.

Additional metrics include Laplacian variance for measuring overall sharpness, local entropy for texture richness, and histogram spread in DCT space. These features are concatenated and normalized into a 256-dimensional fingerprint vector. The vector may be stored as a NumPy-style float32 array or as compressed MessagePack format. Feature maps may be visualized for debugging and validation.

Thresholds may be used to trigger processing routes-for example, PSNR below 25 dB, or Laplacian variance below 100, may prompt fallback to DCT-based inference. These fingerprints also serve as cache query keys in the PCM system. The degradation fingerprint extraction process generates a 256-dimensional feature vector through the following steps: (1) Sobel edge detection using 3×3 kernels produces horizontal and vertical edge maps; (2) Fast Fourier Transform analysis of 8×8 image patches computes power spectral density distributions; (3) Statistical moments (mean μ, variance σ², skewness γ₁, kurtosis γ₂) are calculated across spectral responses; (4) Laplacian variance measures overall sharpness as Var (∇²I); (5) Local entropy quantifies texture richness using H=−Σp(i)log₂p(i); (6) All features are L2-normalized and concatenated into the final fingerprint vector f∈ [symbol] .

Within the PCM framework, visual processing strategies are implemented as specialized “thoughts”—structured cognitive objects that encapsulate both declarative knowledge about image degradation patterns and procedural knowledge about correction methods. Each visual strategy thought comprises: (1) a symbolic representation describing the degradation type and severity; (2) a parametric representation containing specific DCT coefficients and network weights; and (3) a procedural representation encoding the sequence of processing operations. The thought representation enables sophisticated reasoning about visual processing

strategies. For instance, when encountering a novel degradation pattern, the system can generate hypotheses about effective correction approaches by analogizing to similar patterns in its thought cache. This reasoning process follows the same architectural principles used for language understanding tasks, where the system generates intermediate reasoning steps (“thoughts”) before producing final responses.

Visual strategy thoughts are stored using the same memory architecture as linguistic thoughts, with short-term memory maintaining recently applied strategies and long-term memory consolidating proven approaches. The unified storage format enables cross-pollination between visual and linguistic processing—for example, sequential reasoning patterns learned in language tasks can inform multi-stage visual enhancement pipelines.

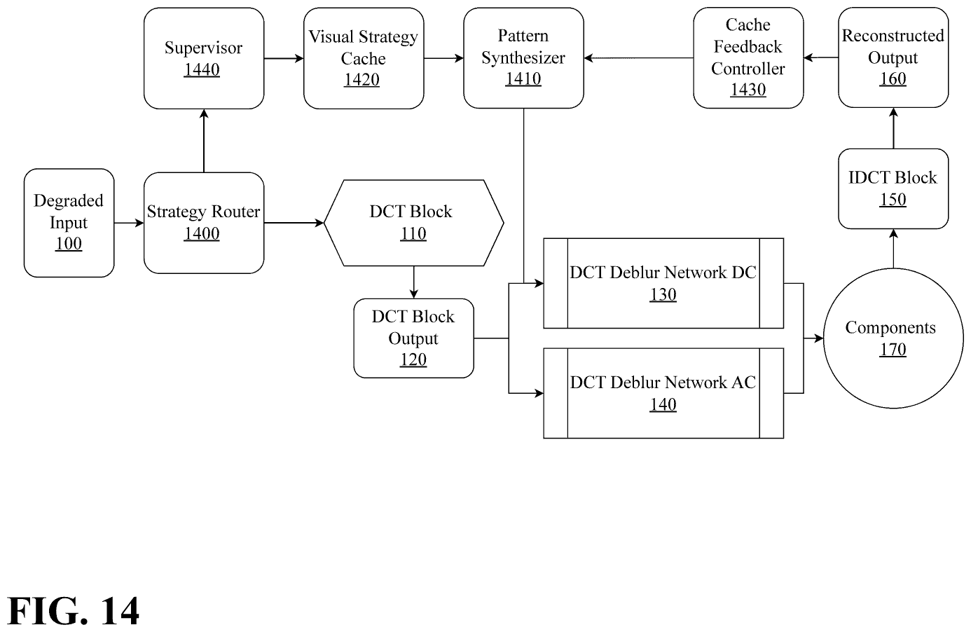

FIG. 14 is a block diagram illustrating an exemplary system architecture for adaptive real time discrete cosine transform image and video processing with convolutional neural network architecture enhanced with visual strategy caching capabilities. The system receives degraded input 100 which represents an image or video frame containing various types of degradation such as motion blur, defocus blur, or compression artifacts. A strategy router 1400 serves as the initial decision-making component that analyzes the degraded input to determine whether to utilize cached processing strategies or perform full DCT analysis. Strategy router 1400 examines the degraded input's characteristics by extracting features such as blur patterns, noise levels, and artifact signatures, comparing these features against a database of known degradation types stored within its decision logic.

When strategy router 1400 determines that no suitable cached strategies exist for the current degradation pattern, it routes degraded input 100 to DCT block 110 for traditional processing. DCT block 110 performs a discrete cosine transform, typically using a 4×4 blockwise transformation, to convert the spatial domain image into frequency domain representations. This transformation produces DCT block output 120 comprising multiple subband images that separate the image information into different frequency components. DCT block output 120 is then processed through parallel DCT deblur network channels, including DCT deblur network DC 130 for processing low-frequency components and DCT deblur network AC 140 for processing high-frequency components. These networks apply learned deblurring strategies specific to their respective frequency domains, with the DC network focusing on overall image structure and the AC network addressing fine details and edges.

The processed frequency components from both deblur networks converge at components 170, which represents the deblurred frequency domain data ready for reconstruction. These components are passed to IDCT block 150 that performs an inverse discrete cosine transform to convert the processed frequency domain data back into the spatial domain, producing reconstructed output 160. This reconstructed output represents the enhanced version of the original degraded input with blur and artifacts removed or significantly reduced.

A cache feedback controller 1430 monitors the quality of reconstructed output 160 and determines whether the processing strategy used was successful enough to warrant caching. Cache feedback controller 1430 evaluates metrics such as peak signal-to-noise ratio (PSNR), structural similarity index (SSIM), and perceptual quality measures. When the quality metrics exceed predetermined thresholds, indicating a successful deblurring operation, cache feedback controller 1430 signals a supervisor 1440 to initiate the caching process.

Supervisor 1440 manages the overall caching operations and coordinates between different cache-related components. Upon receiving a positive signal from cache feedback controller 1430, supervisor 1440 extracts the processing parameters used by the DCT deblur networks, including filter coefficients, network weights for specific layers, and transformation parameters. These parameters, along with a fingerprint of the original degradation pattern, are stored in a visual strategy cache 1420. Visual strategy cache 1420 maintains a structured database of successful processing strategies, indexed by degradation type and severity, enabling rapid retrieval for future similar inputs.

When strategy router 1400 encounters a degraded input with characteristics matching previously cached strategies, it can bypass computationally intensive DCT block 110 processing. Instead, the router retrieves relevant strategies from visual strategy cache 1420 and forwards them to a pattern synthesizer 1410. Pattern synthesizer 1410 becomes particularly aids when the degraded input exhibits multiple types of degradation that individually match different cached strategies. For example, if an image suffers from both motion blur and low-light noise, the pattern synthesizer 1410 can retrieve separate strategies for each degradation type from visual strategy cache 1420 and combine them using weighted merging or hierarchical application methods.

Pattern synthesizer 1410 employs algorithms to merge multiple strategies without creating conflicts or artifacts. It analyzes the relationships between different degradation types and their corresponding solutions, determining optimal combination weights based on the relative severity of each degradation. The synthesized strategy is then applied directly to configure DCT deblur networks 130 and 140, bypassing the DCT block 110 entirely. This approach significantly reduces computational overhead while maintaining high-quality results, as the networks can be pre-configured with proven parameters rather than requiring full frequency analysis.

The system creates a continuous learning loop where successful processing strategies are accumulated over time, progressively improving efficiency as visual strategy cache 1420 becomes more comprehensive. Supervisor 1440 also implements cache management policies, such as removing rarely used strategies or consolidating similar strategies to optimize storage.

Through this architecture, the system achieves adaptive processing that becomes more efficient with use while maintaining the high-quality deblurring capabilities of the original DCT-based approach.

The PCM router 2110 serves as a universal cognitive dispatcher that determines whether incoming processing requests—whether visual degradation correction or natural language understanding—should utilize cached strategies (thoughts) or engage in novel strategy generation. The router analyzes input characteristics using domain-specific feature extractors but applies consistent similarity matching algorithms across all cognitive domains.

When processing visual inputs, the router extracts degradation fingerprints. When processing linguistic inputs, the router extracts semantic and syntactic features using natural language processing techniques. Both feature types are projected into the same latent space using domain-specific encoders, enabling unified similarity comparisons and strategy retrieval.

The pattern synthesizer 1410 operates identically for both visual and linguistic tasks, combining multiple retrieved strategies using weighted geodesic interpolation in the shared latent space. This unified synthesis mechanism enables novel capabilities such as applying visual composition principles to language generation or using linguistic reasoning patterns to guide multi-stage image processing workflows.

According to one embodiment, the PCM system performs nearest-neighbor matching of degradation fingerprints using vector-based similarity metrics. Each incoming fingerprint vector is compared against cached vectors using cosine similarity: similarity (a,b)=(a*b)(∥a∥*∥b∥). Alternatively, Euclidean distance may be used. Matching proceeds only if similarity exceeds a relevance threshold T, typically set to 0.85 for cosine similarity or a normalized distance under 0.3. To reduce lookup time, the system may index fingerprints using Approximate Nearest Neighbor (ANN) libraries such as FAISS, Annoy, or ScaNN.

In a preferred embodiment, the relevance threshold is set to 0.85 for cosine similarity matching, though this may be adjusted based on application requirements between 0.7 and 0.95

The system implements a multi-stage similarity matching algorithm that combines multiple distance metrics for robust strategy retrieval. The primary matching process begins with hash-based indexing where the 256-dimensional degradation fingerprint is processed through locality-sensitive hashing (LSH) using random projection matrices. A set of 64 hash functions h_i(x)=sign(w_i·x+b_i) generates binary signatures, where w_i represents random Gaussian vectors and b_i are random offsets. The LSH process creates hash buckets containing potentially similar fingerprints, reducing the search space from thousands of cached strategies to typically 10-50 candidates. For each candidate strategy, the system computes cosine similarity using the formula: cos_sim(a,b)=(a·b)/(∥a∥₂×∥b∥₂). When cosine similarity exceeds 0.85, the system additionally validates the match using Euclidean distance: euclidean_dist=sqrt(Σᵢ(aᵢ−bᵢ)²). A strategy qualifies for retrieval when both cosine_sim>0.85 AND euclidean_dist<0.3×max_fingerprint_magnitude. For degradations with temporal components (e.g., motion blur), the system applies weighted similarity where recent strategies receive higher relevance scores using exponential decay: relevance_score=base_similarity×exp(−λ×time_since_creation), with λ=0.1 per day. The matching algorithm maintains performance through approximate nearest neighbor search using FAISS IndexIVFFlat with 256 clusters and nprobe=16 for query expansion.

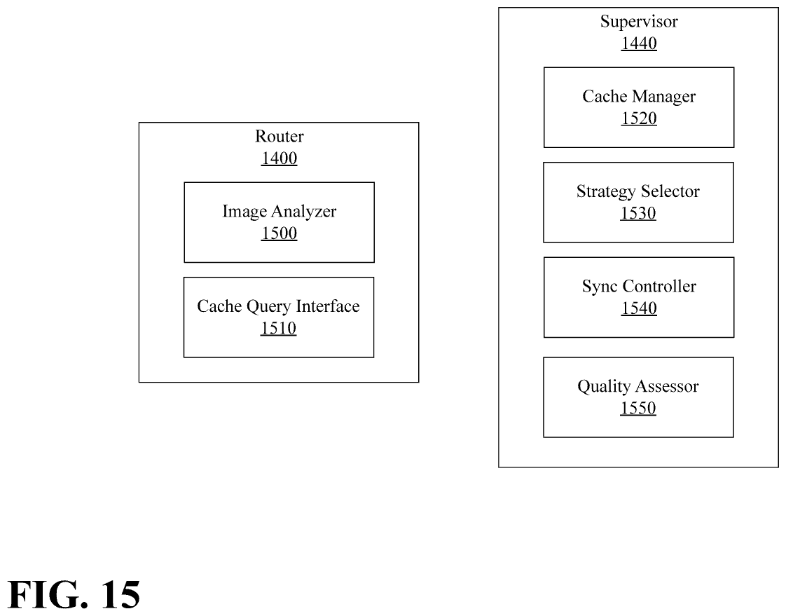

FIG. 15 is a block diagram illustrating an exemplary component for adaptive real time discrete cosine transform image and video processing with convolutional neural network architecture, the router and supervisor. Router 1400 serves as the primary decision-making component that determines whether incoming degraded images should undergo full DCT processing or can utilize cached visual strategies for more efficient processing.

Within router 1400, an image analyzer 1500 performs the initial assessment of incoming degraded images. Image analyzer 1500 employs multiple analysis techniques to characterize the type and severity of degradation present in the input image. It extracts features such as edge sharpness metrics to detect motion blur, frequency distribution patterns to identify compression artifacts, and noise statistics to recognize various noise types. For example, when analyzing an image with motion blur, image analyzer 1500 might detect directional smearing in the frequency domain and characteristic reduction in high-frequency components along the direction of motion. The analyzer generates a comprehensive degradation profile that includes identified degradation types, their relative severities, and spatial distribution within the image.

A cache query interface 1510 receives the degradation profile from the image analyzer 1500 and formulates efficient queries to search the visual strategy cache. Cache query interface 1510 translates the high-dimensional degradation profile into optimized search parameters, potentially using techniques such as locality-sensitive hashing or vector similarity measures. It constructs queries that can efficiently search through potentially thousands of cached strategies, prioritizing exact matches while also identifying partially matching strategies that might be suitable for synthesis. The interface manages multiple parallel queries when the degradation profile indicates multiple concurrent degradation types, such as an image suffering from both motion blur and JPEG compression artifacts.

Supervisor 1440 oversees the cache-related operations and coordinates the activities of

multiple specialized components. A cache manager 1520 within supervisor 1440 handles the storage, retrieval, and maintenance of visual strategies in the cache. Cache manager 1520 implements sophisticated indexing structures that enable rapid retrieval based on degradation characteristics. It maintains metadata for each cached strategy including usage frequency, success rates, creation timestamps, and relationship mappings to other strategies. Cache manager 1520 may also implement storage optimization techniques such as but not limited to compression of similar strategies and hierarchical organization where general strategies can be refined into more specific variants.

A strategy selector 1530 evaluates the query results from cache query interface 1510 and makes intelligent decisions about which strategies to use. When multiple potentially suitable strategies are found, strategy selector 1530 employs ranking algorithms that consider factors such as historical success rates for similar images, computational complexity of each strategy, and confidence scores based on the match quality between the cached degradation profile and the current image's profile. For instance, if three strategies are found for motion blur correction with confidence scores of 0.92, 0.85, and 0.78, strategy selector 1530 might choose the highest-scoring strategy for direct application or select multiple strategies for synthesis if their combination would better address the specific degradation pattern.

A sync controller 1540 manages the coordination between different cache operations and ensures consistency when multiple processing threads or devices access the cache simultaneously. In implementations where the visual strategy cache might be shared across multiple processing units or devices, sync controller 1540 implements locking mechanisms to prevent conflicting updates and ensures that newly added strategies are properly propagated throughout the system. It manages version control for strategies that might be updated based on new processing results and handles conflict resolution when different processing units generate different strategies for similar degradation patterns.

A quality assessor 1550 continuously evaluates the effectiveness of cached strategies and

provides feedback for cache optimization. Quality assessor 1550 monitors the outcomes when cached strategies are applied, comparing the quality metrics of processed images against expected thresholds. It tracks metrics such as peak signal-to-noise ratio improvements, structural similarity scores, and perceptual quality measures. When a cached strategy consistently underperforms, quality assessor 1550 can flag it for removal or update. Conversely, strategies that consistently exceed performance expectations might be promoted to preferred status or used as bases for generating related strategies.

The components within router 1400 and supervisor 1440 work in concert to create an intelligent caching system that improves over time. As more images are processed, the system accumulates a richer set of strategies, and the various components refine their operations based on accumulated performance data. Image analyzer 1500 can learn to extract more discriminative features, cache query interface 1510 can optimize its search patterns based on successful retrievals, and strategy selector 1530 can improve its ranking algorithms based on outcome feedback from quality assessor 1550. This creates a self-improving system that becomes more efficient and effective with use while maintaining high processing quality.

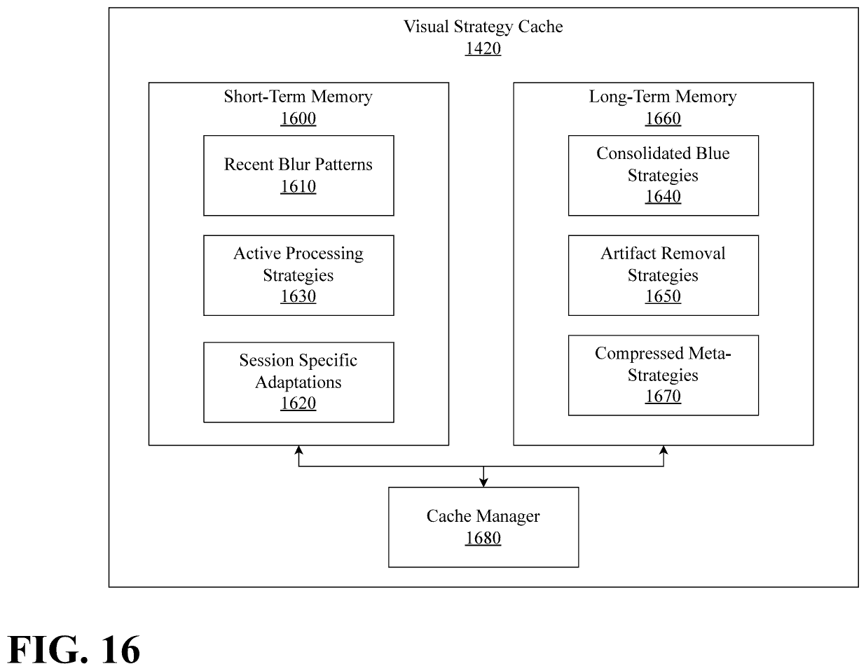

FIG. 16 is a block diagram illustrating an exemplary architecture for a visual strategy cache that implements a hierarchical memory system for storing and managing image processing strategies. Visual strategy cache 1420 may be organized into two primary memory tiers: a short-term memory 1600 and a long-term memory 1660, each serving distinct purposes in the overall caching strategy and optimized for different access patterns and storage requirements.

Short-term memory 1600 maintains high-priority, frequently accessed visual strategies that are most relevant to current processing sessions. Within short-term memory 1600, recent blur patterns 1610 stores detailed information about blur characteristics encountered in recently processed images. These patterns include parametric descriptions of motion blur vectors, defocus blur radii, and atmospheric blur characteristics, along with the specific DCT parameters that successfully corrected each blur type. For example, when processing a sequence of frames from a handheld video, recent blur patterns 1610 might store the characteristic shake patterns and their corresponding stabilization parameters, enabling rapid correction of subsequent frames with similar motion profiles.

Active processing strategies 1630 contains the complete processing pipelines currently in use or recently applied to images. These strategies encompass not only the deblurring parameters but also the specific configurations of the DCT deblur networks, including active neurons, weight modifications, and processing sequences. Each active strategy maintains a usage counter and timestamp to track its relevance and recency. When multiple images from the same source or captured under similar conditions are processed, active processing strategies 1630 enables immediate reuse of proven configurations without reanalysis, significantly reducing computational overhead.

Session specific adaptations 1620 stores temporary modifications and refinements made to standard strategies during the current processing session. These adaptations capture user preferences, device-specific optimizations, or environmental factors that influence processing decisions. For instance, if a user consistently prefers slightly sharper outputs than the default processing provides, session specific adaptations 1620 records these preference adjustments and automatically applies them to subsequent processing within the session. These adaptations are typically volatile and may be discarded between sessions unless explicitly promoted to permanent storage.

Long-term memory 1660 serves as a persistent repository for proven, validated strategies that have demonstrated consistent effectiveness across multiple processing sessions. Consolidated blur strategies 1640 represents the result of analyzing and merging multiple related strategies from the short-term memory that address similar blur types. The consolidation process identifies common patterns across successful blur corrections and creates generalized strategies that can handle variations within a blur category. For example, multiple strategies for correcting handheld camera shake at different speeds might be consolidated into a parameterized strategy that adapts to shake velocity.

Artifact removal strategies 1650 specifically addresses various types of image artifacts including compression artifacts, sensor noise, and optical aberrations. These strategies are organized by artifact type and severity level, with each strategy containing the specific frequency domain manipulations required to suppress the artifacts while preserving image detail. The strategies include learned patterns for distinguishing between artifact signatures and legitimate image features, preventing over-correction that might remove important image content.

Compressed meta-strategies 1670 represents the highest level of abstraction in the cache hierarchy, where multiple related strategies are compressed into compact representations that capture essential processing patterns. These meta-strategies use techniques such as principal component analysis or neural network compression to reduce storage requirements while maintaining the ability to reconstruct full strategies when needed. A meta-strategy might encode the general approach for handling all motion-related degradations, from which specific strategies for camera shake, object motion, or panning blur can be derived.

A cache manager 1680 orchestrates the movement of strategies between memory tiers and maintains the overall health of the cache system. Cache manager 1680 implements policies for promoting strategies from short-term to long-term memory based on usage frequency, success rates, and uniqueness criteria. It monitors the storage capacity of each memory tier and implements eviction policies when space constraints are reached. Cache manager 1680 uses algorithms such as least recently used (LRU) with modifications that consider strategy importance and computational cost of regeneration.

The cache manager implements a sophisticated multi-tier storage architecture with automated lifecycle management and performance optimization. The system employs a three-tier storage hierarchy: L1 cache (256 MB DRAM) for frequently accessed strategies with sub-microsecond retrieval, L2 cache (4 GB NVME SSD) for medium-term storage with millisecond access times, and L3 archive (unlimited network storage) for long-term retention with second-level access. Strategy promotion and demotion follow algorithmic rules based on access patterns and performance metrics. The L1 eviction policy combines LRU with weighted utility scoring: utility_score=access_frequency×recency_weight×success_rate×(1−storage_cost_factor), where recency_weight=exp(−0.1×days_since_last_access), success_rate represents the fraction of successful applications, and storage_cost_factor accounts for strategy size. Strategies are evicted when L1 reaches 90% capacity, with the lowest-scoring 25% of strategies moved to L2. The cache maintains detailed metadata for each strategy including: creation timestamp, last access time, access count, cumulative success rate, average processing time, storage size, and dependency relationships. Database schema uses PostgreSQL with tables: strategies (id, fingerprint_hash, parameters_blob, metadata_json, created_at, updated_at), access_logs (strategy_id, timestamp, success_boolean, processing_time_ms), and relationships (parent_id, child_id, relationship_type, weight). Indexing uses B-tree on fingerprint_hash, GIN on metadata_json, and BRIN on timestamps for efficient temporal queries. Cache coherence across distributed instances uses a gossip protocol with eventual consistency: each node broadcasts digest updates every 30 seconds containing hash (strategy_id+version+checksum), with conflicts resolved using vector clocks. Garbage collection runs nightly, identifying orphaned strategies (no access in 30 days, success rate<0.3) for archival. The system maintains cache hit rate>85% through predictive preloading: a neural network trained on access patterns predicts future strategy needs with 72-hour lookahead, automatically promoting strategies from L2 to L1 when prediction confidence>0.8.

Cache manager 1680 also performs periodic maintenance operations including strategy validation, where older strategies are tested against current processing standards to ensure continued effectiveness, and relationship mapping, where connections between related strategies are identified and strengthened. It implements garbage collection to remove obsolete or redundant strategies and performs defragmentation to optimize memory layout for faster access. Strategies and information may be passed between short-term memory 1600 and long-term memory 1660 through cache manager 1680 based on their lifecycle, with successful short-term strategies being promoted to long-term storage and relevant long-term strategies being loaded into short-term memory for active use.

This hierarchical organization enables visual strategy cache 1420 to maintain a balance between immediate accessibility for current processing needs and comprehensive coverage for diverse image degradation scenarios. The structure supports both rapid response for known degradation patterns and continuous learning as new strategies are developed and validated through actual use.

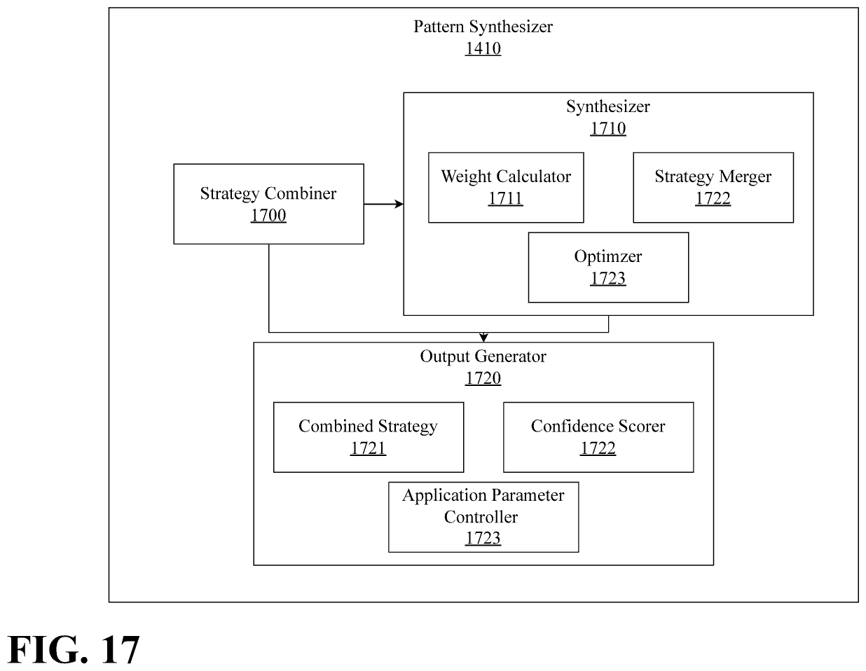

FIG. 17 is a block diagram illustrating an exemplary architecture for a pattern synthesizer enables intelligent combination of multiple visual processing strategies to address complex image degradations. Pattern synthesizer 1410 serves as a critical component when degraded images exhibit multiple concurrent degradation types that cannot be adequately addressed by a single cached strategy.

A strategy combiner 1700 functions as the initial reception point for multiple visual strategies retrieved from the visual strategy cache. Strategy combiner 1700 analyzes the relationships between incoming strategies to determine compatibility and potential conflicts. For example, when receiving a motion blur correction strategy and a noise reduction strategy, strategy combiner 1700 evaluates whether the frequency domain operations of each strategy might interfere with one another. It examines the frequency bands targeted by each strategy, the order dependencies of operations, and potential amplification or cancellation effects that might occur when strategies are combined. Strategy combiner 1700 creates a preliminary combination plan that identifies which aspects of each strategy should be preserved, modified, or merged.

The pattern synthesizer implements a multi-stage weighted combination algorithm that merges multiple cached strategies while preserving their individual effectiveness. The synthesis process begins with compatibility analysis where each pair of strategies is evaluated for potential conflicts. The system examines frequency band overlap using spectral analysis: for strategies S₁ and S₂, overlap_coefficient=Σᵢ min(S₁.freq_weights[i], S₂.freq_weights[i])/Σᵢ max(S₁.freq_weights[i], S₂.freq_weights[i]). When overlap_coefficient>0.7, indicating significant frequency band conflict, the synthesizer applies sequential processing rather than parallel combination. For compatible strategies, weight calculation proceeds as follows: given degradation confidences c₁, c₂ and strategy historical success rates h₁, h₂, the combination weights are computed as w₁=(c₁×h₁)/(c₁×h₁+c₂×h₂) and w₂=1−w₁. The actual parameter synthesis uses element-wise weighted averaging for filter coefficients: combined_filter[i,j]=w₁×filter₁[i,j]+w₂×filter₂[i,j], followed by renormalization to maintain filter energy: normalized_filter=combined_filter×sqrt(Σᵢⱼ original_energy)/sqrt(Σᵢⱼ combined_filter²[i,j]).

For neural network parameters, the system performs layer-wise interpolation with stability checking: if any layer's combined weights exceed stability bounds (gradient norm>10.0), the synthesizer reverts to the higher-confidence strategy with 0.9 weight and lower-confidence strategy with 0.1 weight. The synthesized strategy undergoes validation through a lightweight test on a 64×64 pixel sample patch, and synthesis proceeds only if the test patch shows PSNR improvement>1.5 dB over individual strategies.

A synthesizer 1710 contains the components responsible for creating a unified strategy from multiple inputs. A weight calculator 1711 within synthesizer 1710 determines the relative contribution of each input strategy to the final synthesized result. Weight calculator 1711 employs sophisticated algorithms that consider multiple factors including the severity of each degradation type detected in the input image, the historical success rates of each strategy for similar degradations, and the confidence levels associated with each strategy match. For instance, if motion blur is detected with 90% confidence and compression artifacts with 60% confidence, weight calculator 1711 might assign weights of 0.6 and 0.4 respectively to ensure the motion blur correction receives appropriate emphasis while still addressing the compression artifacts.

A strategy merger 1722 performs the actual combination of weighted strategies into a cohesive processing pipeline. Strategy merger 1722 operates at multiple levels, combining both the parametric aspects of strategies such as filter coefficients and threshold values, and the structural aspects such as processing order and network configurations. When merging strategies, it resolves conflicts through various techniques including sequential application where non-interfering operations are performed in optimal order, parallel application where independent corrections can be applied simultaneously to different frequency bands, and integrated application where similar operations from different strategies are combined into more efficient unified operations. Strategy merger 1722 ensures that the combined strategy maintains mathematical consistency and avoids operations that would cancel each other's effects.

An optimizer 1723 refines the merged strategy to improve efficiency and effectiveness. Optimizer 1723 identifies redundant operations that may have resulted from combining multiple strategies and consolidates them into more efficient forms. It analyzes the computational complexity of the merged strategy and seeks opportunities to reduce processing time without sacrificing quality. For example, if two strategies both include edge enhancement steps with different parameters, optimizer 1723 might combine them into a single, more sophisticated edge enhancement operation. Optimizer 1723 also performs stability analysis to ensure the combined strategy won't produce artifacts or instabilities when applied to the DCT deblur networks.

An output generator 1720 packages the synthesized strategy into formats suitable for application to the image processing pipeline. Output generator 1720 produces outputs that work together to enable effective application of the synthesized strategy. A combined strategy 1721 contains the complete set of processing parameters, network configurations, and operational sequences that constitute the synthesized approach. This includes detailed specifications for each DCT deblur network channel, such as modified convolution kernels for specific frequency bands, adjusted activation thresholds for artifact detection, and customized weight matrices for the neural network layers.

A confidence scorer 1722 generates reliability metrics for the synthesized strategy based on the synthesis process and input strategy qualities. Confidence scorer 1722 considers factors such as the compatibility of the merged strategies, the amount of modification required during optimization, and the predicted effectiveness based on similar historical combinations. It produces both an overall confidence score for the entire synthesized strategy and component-level scores that indicate confidence in specific aspects of the processing. These scores enable downstream components to make informed decisions about whether to apply the synthesized strategy or fall back to traditional processing methods.

An application parameter controller 1723 translates the abstract strategy specifications into concrete control parameters for the DCT deblur networks and other processing components. Application parameter controller 1723 handles the mapping between high-level strategy descriptions and low-level implementation details, accounting for hardware-specific optimizations and constraints. It generates timing sequences for applying different aspects of the strategy, memory allocation requirements for temporary buffers needed during processing, and synchronization parameters when parallel operations are involved. The controller ensures that the synthesized strategy can be smoothly integrated into the existing processing pipeline without disrupting the real-time performance characteristics of the system.

Pattern synthesizer 1410 enables the system to address complex, multi-faceted image degradations that would be difficult or impossible to correct using single strategies. By intelligently combining proven approaches for individual degradation types, it creates sophisticated processing pipelines that can handle real-world images where multiple degradation sources are present simultaneously. The hierarchical organization from strategy combination through synthesis to output generation ensures that the combined strategies are both theoretically sound and practically implementable within the constraints of the real-time processing system.

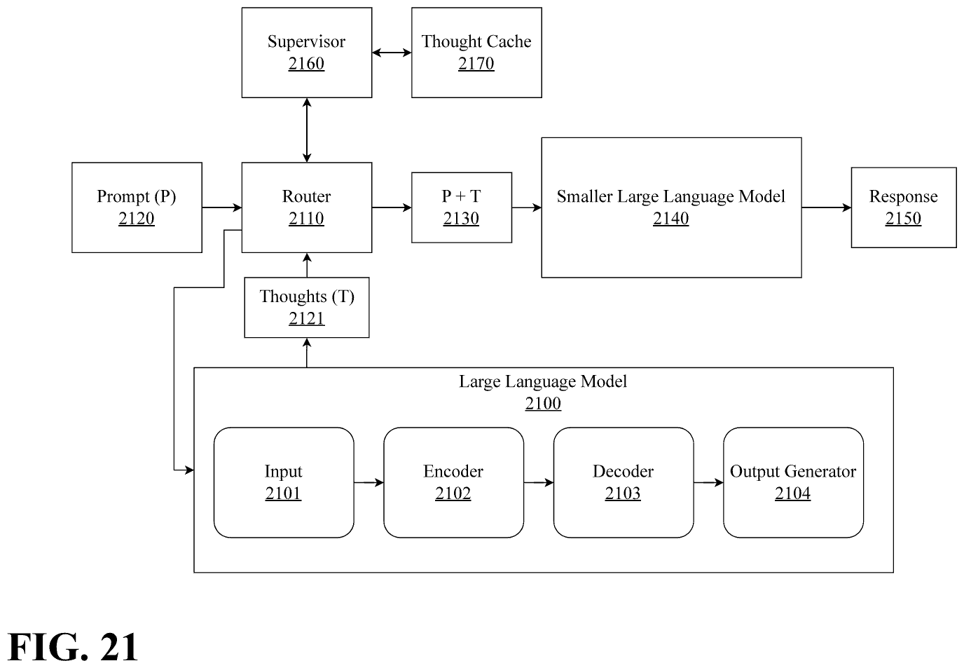

FIG. 21 is a block diagram illustrating an exemplary system architecture for a multi-state LLM with unlimited context. The system includes a large language model 2100, a router 2110, a controller 2160, a thought cache 2170, and a smaller language model 2140 that work together to process prompts and generate responses while optimizing computational resources.

The system receives an initial prompt (P) 2120 through the router 2110. The router serves as the central control component, determining whether to utilize the large language model 2100 or access the thought cache 2170 through the controller 2160. Upon receiving a prompt, the router first queries the thought cache to determine if relevant thoughts exist for similar prompts.

The large language model 2100 includes an input component 2101, an encoder 2102, a decoder 2103, and an output generator 2104. The large language model 2100 can utilize various internal architectures, including but not limited to traditional transformer cores. The model's attention mechanisms can be implemented using either standard multi-head attention (MHA) or multi-head latent attention (MLA), with the overall system functioning identically regardless of the specific attention mechanism chosen. When using MLA, the model benefits from reduced KV cache requirements during inference while maintaining performance comparable to or better than traditional MHA implementations. When the router determines that cached thoughts are not available or suitable, the prompt is processed through the large language model 2100. During this processing, the model enters a reasoning phase where it generates thoughts (T) 2121 about the prompt. These thoughts represent the model's analysis and reasoning about the prompt before generating a final response.

The supervisor 2160 manages interaction with the thought cache 2170, which can be implemented as either a local or cloud-based storage system. The thought cache stores previously generated thoughts in a vector database format, allowing for efficient retrieval of relevant thoughts for similar prompts. The cache can maintain both session-specific thoughts for temporary storage and long-term thoughts for persistent knowledge.

When thoughts are either generated by the large language model or retrieved from the cache, they are combined with the original prompt to create a prompt and thought combination (P+T) 2130. This combination is then routed to the smaller language model 2140, which requires significantly fewer computational resources than the large model. The smaller model processes the P+T 2130 combination to generate the final response 2150.

In operation, for example, if a user submits a prompt asking about climate change impacts, the router first checks the thought cache for relevant existing thoughts. If suitable thoughts exist, they are retrieved and combined with the prompt. If no relevant thoughts are found, the large model processes the prompt to generate new thoughts about climate science, global impacts, and relevant data. These thoughts, combined with the original prompt, are then processed by the smaller model 2140 to generate a concise, relevant response. The new thoughts are also cached for future use. To demonstrate how thoughts are created, imagine the prompt “What do you think is the future of string theory, particularly given the spectacular failure of supersymmetry at LHC” being entered into the LLM DeepSeek. During the reasoning phase, the model returns to the user the following thoughts:

“Okay, the user is asking about the future of string theory in light of supersymmetry not being found at the LHC. Let me start by recalling what I know about string theory and SUSY.

String theory relies heavily on supersymmetry because SUSY helps stabilize the extra dimensions and makes the math work better. But the LHC hasn't found any superpartners, which challenges some of the more popular SUSY models. However, I should note that SUSY isn't the only part of string theory. There are versions without it, like bosonic string theory, but those aren't as developed or realistic.

The user might be implying that since SUSY isn't found, string theory is in trouble. I need to address that but also explain why it's not the whole story. Maybe mention that SUSY could still exist at higher energy scales beyond LHC's reach. Also, string theory has other applications beyond particle physics, like in condensed matter or quantum gravity.

I should break down the response into points. First, clarify the relationship between SUSY and string theory. Then discuss the LHC results and their implications. Talk about other areas where string theory contributes, like holography or black hole physics. Mention alternatives within string theory that don't rely on low-energy SUSY. Also, touch on the possibility of future experiments or theoretical breakthroughs.

Need to be balanced. Acknowledge the challenges but also the potential. Avoid being too dismissive or overly optimistic. Maybe conclude by saying the future is uncertain but still active in different areas. Check if there are recent developments post-LHC that I should consider, but since the user didn't specify, stick to general points.

Make sure to explain technical terms like “landscape” or “holography” briefly. Keep the language accessible but precise. The user might be someone with a basic understanding of physics, possibly a student or enthusiast. They want to know if string theory is still viable and where it's headed. They might also be interested in how scientific theories adapt when experimental evidence is lacking.

In summary, structure the answer to address the SUSY issue, discuss other aspects of string theory, mention alternative research directions, and conclude with the ongoing relevance despite challenges. Ensure each point flows logically and answers the user's concern about the theory's future post-LHC results.” Using the above generated thoughts, model generated a response to the user's query.

The above thoughts represent T in the accompanying FIG. 21. By extracting thoughts generated by a model in their reasoning phase and passing both those thoughts and the initial prompt through a substantially smaller model with less parameters, the same response may be given while using much less energy.

The system supports multiple cache architectures, including but not limited to local device storage for personal use and cloud-based storage for enterprise applications. This allows for knowledge sharing across users while maintaining appropriate privacy and access controls. Multiple specialized caches can exist for different domains or use cases, such as financial analysis or scientific research.

The system supports multiple specialized cache architectures that enable domain-specific knowledge storage and AI agent collaboration. These architectures include but are not limited to local device caches for personal use, edge caches for specific AI agents, and distributed cloud-based caches for enterprise applications. Each specialized cache maintains its own thought organization optimized for its domain—for instance, a financial analysis cache might structure thoughts around market patterns and risk assessment frameworks, while a scientific research cache might organize thoughts based on experimental methodologies and theoretical frameworks. AI agents can be assigned primary affinity to specific specialized caches while maintaining ability to access other caches when needed. For example, a financial analysis agent might primarily interact with the financial cache but could access the scientific research cache when analyzing biotechnology investments. The system implements cache-specific validation rules and quality metrics tailored to each domain's requirements-financial thoughts might require numerical accuracy validation, while scientific thoughts might undergo peer-review-style verification by other AI agents. These specialized caches can operate independently or in interconnected hierarchies, with bridge agents managing thought transfer between different domains. Enterprise deployments can maintain multiple parallel specialized caches with varying access levels, enabling selective knowledge sharing while preserving security boundaries. For instance, a pharmaceutical company might maintain separate but interconnected caches for public research, proprietary development, and regulatory compliance, with AI agents navigating these boundaries based on clearance levels and task requirements.

The system achieves effectively unlimited context windows through a combination of thought abstraction and hierarchical memory management. Rather than attempting to maintain extended token sequences, the system is capable of converting contextual information into thought representations that capture higher-level patterns and relationships. These thoughts serve as compressed encodings of context, where each thought unit may encapsulate understanding that would traditionally require thousands of tokens to represent.

In one embodiment, the system implements a multi-tier thought storage architecture where context exists simultaneously at multiple levels of abstraction. The most recent context maintains detailed thought representations with full fidelity, while older context is progressively synthesized into more abstract thought patterns that capture essential relationships and understanding while reducing storage requirements. This progressive abstraction allows the system to maintain effectively unlimited context while managing computational resources efficiently.

When processing new prompts, router 2110 analyzes both recent detailed thoughts and older abstract thoughts to identify relevant context. A thought synthesizer 2230 can then combine these different levels of abstraction to generate new thoughts that incorporate both immediate context and long-term understanding. This multi-level synthesis enables the system to maintain contextual coherence across extended interactions without requiring linear scaling of computational resources.

Thought cache 2170 implements indexing structures that maintain temporal relationships between thoughts while enabling efficient retrieval based on relevance. Unlike traditional attention mechanisms that must process entire token sequences, the system can directly access relevant thoughts across any temporal distance through its hierarchical indexing system. This capability allows the model to maintain contextual awareness across arbitrarily long sequences while keeping retrieval costs nearly constant.

In one embodiment, thought cache 2170 implements multiple storage tiers that automatically organize thoughts based on their temporal relevance and utilization patterns. In its primary tier, the thought cache maintains recent thoughts with their complete reasoning chains and relationship mappings intact. As these thoughts age within the cache, specialized consolidation mechanisms within the cache combine related thoughts into more efficient meta-thoughts that preserve essential reasoning while reducing storage overhead.

Thought cache 2170 monitors access patterns and triggers consolidation events when thought clusters meet specific temporal or utilization thresholds. During these events, thought cache 2170 analyzes thought clusters using its built-in synthesis capabilities to generate consolidated meta-thoughts. These meta-thoughts capture insights and relationships from the original thought cluster while requiring significantly less storage space. For example, a sequence of thoughts about various machine learning algorithms might consolidate into a meta-thought capturing their comparative advantages and key implementation considerations.

Intelligence within thought cache 2170 adapts consolidation timing based on thought utility metrics. Thought cache 2170 tracks each thought's retrieval frequency, synthesis participation, and relationship density with other thoughts. Thoughts demonstrating high utility retain their detailed form longer, while less frequently accessed thoughts undergo earlier consolidation. This adaptive approach ensures that frequently needed reasoning patterns remain readily available in their most useful form.

Thought cache's 2170 hierarchical storage structure spans multiple performance tiers, from high-speed memory for recent and frequently accessed thoughts to more economical storage for consolidated meta-thoughts. Thought cache 2170 may migrate thoughts between these tiers based on usage patterns and age, optimizing storage resource utilization while maintaining rapid access to relevant contextual information. This tiered structure enables the cache to efficiently manage large volumes of thoughts while keeping the most pertinent information readily accessible.

Thought cache 2170 implements a universal thought representation format that enables consistent interpretation across different language models and reasoning contexts. This standardization occurs through a formal thought schema that defines how reasoning steps, logical relationships, and contextual dependencies are encoded. Each thought contains structured fields for core reasoning components, metadata describing the thought's context and assumptions, and explicit markers for temporal and logical dependencies. This structured format ensures that thoughts remain interpretable regardless of which model originally generated them or which model ultimately consumes them.

Before a cached thought is applied to a new context, the system may perform an automated compatibility analysis. This analysis examines both the structural alignment between the cached thought and the current context, and the semantic applicability of the reasoning pattern. The system maintains model-specific adapters that can transform thoughts between different models' preferred reasoning styles while preserving the core logical structure. These adapters handle variations in formatting, vocabulary, and reasoning granularity, ensuring smooth thought transfer between models with different characteristics.

The cache incorporates a contextual validation layer that assesses thought applicability before reuse. When retrieving a cached thought, this layer examines the current prompt's context against the thought's encoded assumptions and dependencies. If misalignments are detected, the system can automatically generate bridging thoughts that reconcile differences between the cached reasoning and the current context. For example, if a cached mathematical proof assumes certain preconditions that differ slightly from the current problem, the system generates additional reasoning steps to account for these differences.

The system's thought schema includes explicit version controls and model compatibility markers. These markers identify which model versions and architectures have successfully utilized each thought, enabling the cache to predict compatibility issues before attempting thought reuse. When new model versions are deployed, the system can automatically flag thoughts that may require revalidation or adaptation to maintain compatibility with updated model capabilities or knowledge cutoffs.

Through these standardization and compatibility mechanisms, the thought cache ensures reliable thought transfer across different models and contexts while maintaining the integrity of reasoning patterns. The combination of structured thought representation, contextual validation, and adaptive transformation enables efficient thought reuse while preventing inconsistencies or misinterpretations.

Through this architecture, the system achieves effective unlimited context not through brute-force token retention but through intelligent abstraction and synthesis of understanding. The smaller language model can process these thought-based contexts more efficiently than traditional token sequences, enabling contextual reasoning without the computational overhead typically associated with extended context windows.

The system supports multiple architectural approaches for maintaining extended context through thought processing. While transformer-based attention mechanisms provide one implementation path, the system can alternatively employ recurrent neural networks (RNNs) for processing thought sequences. In an RNN-based implementation, thoughts are processed sequentially, with the network's hidden state maintaining a compressed representation of historical context. This approach enables efficient processing of arbitrary-length thought sequences while maintaining a constant memory footprint, as the hidden state size remains fixed regardless of sequence length.

The system may also implement memory networks for thought storage and retrieval. These networks maintain an explicit, addressable memory that stores thought representations and their relationships. Unlike attention mechanisms that must process all context simultaneously, memory networks can selectively access relevant thoughts through content-based addressing. The memory network architecture enables direct access to specific thoughts based on relevance to the current prompt, without requiring linear scanning of the entire context history.

The thought cache itself can be structured as a differentiable neural memory, where thoughts are stored as embeddings that can be smoothly updated and combined. This approach enables the cache to learn optimal thought storage and retrieval patterns through experience, adapting its organization to maximize the utility of cached thoughts. The differentiable memory structure supports gradient-based optimization of thought storage and retrieval operations, allowing the system to continuously improve its context management efficiency.

Hybrid architectures combining multiple approaches can leverage the strengths of each method. For example, in one embodiment, the system might employ RNNs for sequential thought processing while using a memory network for long-term storage, or combine transformer attention for recent context with compressed RNN states for historical context. These hybrid approaches enable flexible scaling of context processing based on specific application requirements and resource constraints.

In some embodiments, the visual strategy cache illustrated in FIG. 14 is implemented as a domain-specific instantiation of the thought cache described in FIG. 21. While FIG. 14 depicts the visual processing components of the system, the underlying memory structure is fully consistent with the PCM framework, including symbolic anchoring, latent geodesic trajectories, and hierarchical memory tiers.

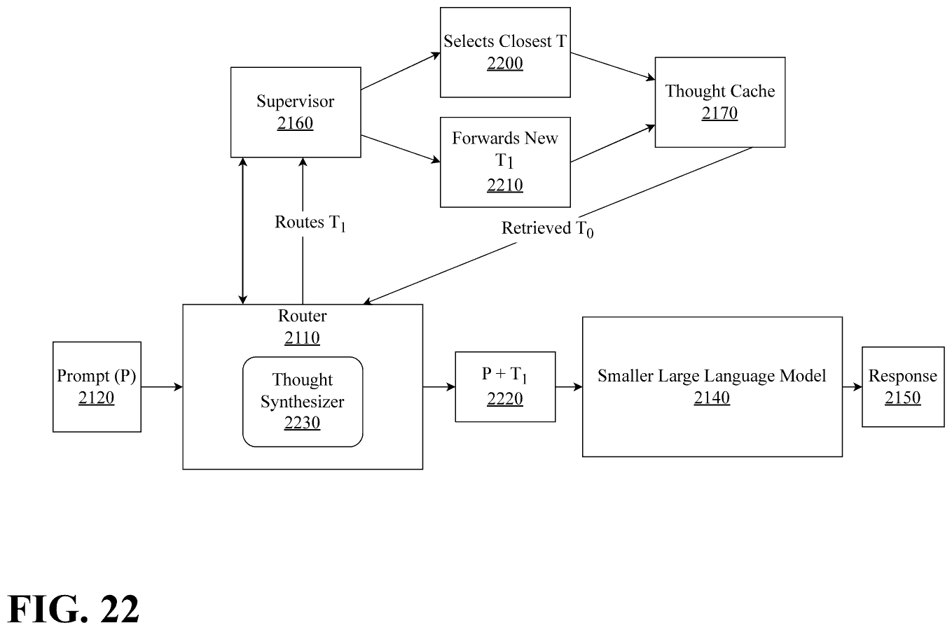

FIG. 22 is a block diagram illustrating an exemplary system architecture for a multi-state LLM with unlimited context with thought synthesis and retrieval. The figure demonstrates how the system handles scenarios where cached thoughts may be relevant but not precisely matched to the current prompt.

The system begins when a prompt (P) 2120 is received by the router 2110. When router 2110 receives a prompt 2120, it interacts with the thought cache 2170 through the controller 2160 to retrieve potentially relevant thoughts.

The controller 2160 performs two key functions in this embodiment. First, it selects the closest thought (T₀) 2200 from the cache that relates to the current prompt. Second, after a synthesizer 2230 creates a new thought T₁ 2210, controller 2160 manages the storage of newly synthesized thoughts. The controller evaluates the retrieved To against certain relevance thresholds to determine if synthesis is needed. These thresholds can be configured based on vector similarity scores between the prompt and the cached thought, with different thresholds potentially being set for different domains or use cases. For example, a threshold of 0.8 (on a 0-1 scale) might indicate the thought is relevant enough to use directly, while scores between 0.5-0.8 might trigger synthesis with other related thoughts, and scores below 0.5 might indicate the need to generate entirely new thoughts using the large model. The system can also employ multiple thresholds simultaneously—one for determining if a thought is “close enough” to use directly, another for determining if thoughts are similar enough to be candidates for synthesis, and another for determining if cached thoughts are relevant enough to be considered at all.

The system can assign and append relevance scores and metadata to thoughts in several ways. When a thought (T) is created by the large model, it can be analyzed and scored across multiple dimensions including but not limited to quality assessment metrics, vector embeddings, usage statistics, and domain tags. Quality assessment encompasses the thought's reasoning pattern quality based on its structure and completeness, accuracy scores for verifiable facts, and confidence scores from the model about its conclusions. Vector embeddings can be calculated and stored with each thought, allowing for fast similarity comparisons during cache lookups, with multiple specialized embeddings potentially stored for different aspects like topic, reasoning style, and domain. Usage statistics track metrics such as success rates when the thought is used (including user feedback), frequency of successful reuse, and performance metrics when used with different types of prompts. Domain tags provide additional context through subject matter categorization, specific topic tags, and required expertise level indicators. These scores and metadata can be stored alongside the thought in the cache in a structured format and updated over time based on usage patterns. The comprehensive metadata enables more sophisticated routing and synthesis decisions while allowing the system to improve its thought selection over time through continuous feedback and performance tracking. For instance, a thought might store its general and domain-specific embeddings, various quality and confidence scores, detailed categorization, and usage statistics, all of which can be used to make more informed decisions about when and how to use or synthesize that thought in future operations.

A synthesizer processes T₀ to create a new thought T₁ that better aligns with the current prompt's requirements. For example, if a prompt asks about specific aspects of quantum computing, and T₀ contains general quantum computing concepts, the synthesizer can create a T₁ that focuses more precisely on the specific aspects requested in the prompt.

Thought synthesizer 2230 combines and processes thoughts when multiple relevant thoughts are found or when existing thoughts need modification. For example, if one cached thought covers quantum bits and another covers error correction, the synthesizer can combine these into a new thought that addresses quantum computing error rates in qubits. The synthesizer can also adapt existing thoughts to better match current prompt requirements. This synthesis process involves understanding the logical relationships between different thoughts, identifying complementary and conflicting information, and creating coherent combinations that preserve the accuracy and context of the original thoughts. The synthesizer employs various combination strategies depending on the relationship between thoughts—it might perform simple concatenation for complementary thoughts, create hierarchical structures for nested concepts, or generate entirely new bridging content to connect related ideas. Additionally, the synthesizer can evaluate the quality of synthesized thoughts and may generate multiple candidate combinations before selecting the most appropriate one based on relevance scores and coherence metrics.

The synthesizer can work with multiple retrieved thoughts simultaneously, combining relevant aspects from each to create a more comprehensive T₁. For instance, if one cached thought contains information about neural networks and another about computer vision, the synthesizer could combine relevant aspects of both to create a new thought more specifically targeted to a prompt about neural networks in computer vision applications.

The system may implement multiple strategies for thought synthesis, enabling the combination of existing cached thoughts to generate new, contextually relevant thoughts without necessarily engaging the large language model. These synthesis mechanisms operate on both the semantic content and vector representations of thoughts, employing various combination strategies depending on the relationship between thoughts and specific prompt requirements. The fundamental approach builds upon vector-based synthesis, where thoughts are represented in a high-dimensional embedding space that preserves semantic relationships through spatial relationships. In one embodiment, when multiple relevant thoughts are retrieved from the cache, their vector representations can be combined through a plurality of mathematical operations to create new thought vectors. These operations may include but are not limited to weighted averaging where more relevant thoughts receive higher weights in the final combination, vector addition with normalization that preserves the directional information of component thoughts, dimensional projection where thoughts are combined along specific semantic dimensions while preserving others, and non-linear combination using learned transformation matrices.

The system demonstrates this vector-based synthesis through concrete applications. For instance, when processing a prompt that requires information about quantum computing's impact on cryptocurrency, and the cache contains separate thoughts about quantum computing (T₁) and cryptocurrency security (T₂), the system performs a weighted combination expressed as T_new=α*T1+β*T2, where a and B represent relevance weights determined by similarity scores between each thought and the prompt. The resulting vector T_new is normalized to maintain consistent magnitude in the embedding space, ensuring that the synthesized thought retains proper proportional representation of its component concepts.

Beyond pure vector operations, the system, in additional embodiments, may employ neural synthesis through a specialized small-scale transformer model trained specifically for thought combination. A neural synthesizer would receive multiple thought vectors as input and generates a new, synthesized thought that captures the relevant aspects of all inputs while maintaining internal consistency. The neural synthesis component is capable of identifying and resolving contradictions between input thoughts, preserving temporal relationships and causal chains, generating bridging content to connect related concepts, and maintaining consistency with the original prompt context. This approach proves particularly valuable when combining thoughts that require subtle understanding of context and implications.

In another embodiment, the system may implement rule-based synthesis through a set of predefined combination patterns based on the logical relationship between thoughts. These patterns support sequential combination for thoughts representing steps in a process, hierarchical combination for thoughts with parent-child relationships, comparative combination for contrasting or parallel thoughts, and supplementary combination for thoughts that provide additional context or examples. The rule-based approach ensures that the structural integrity of thought relationships is preserved during synthesis.

In an embodiment, the system may employ a synthesis quality assessor that evaluates potential thought combinations before they are executed. This assessment examines semantic coherence of the combined thought, preservation of critical information from source thoughts, relevance to the original prompt, and internal consistency of the synthesized thought. The quality assessment process helps prevent the generation and propagation of invalid or inconsistent thought combinations.

In scenarios where multiple synthesis strategies might apply, the system employs a multi-stage synthesis process. This process begins by generating candidate syntheses using different strategies, proceeds to evaluate each candidate using quality metrics, selects the highest-quality synthesis result, and caches the successful synthesis strategy for similar future combinations.

This approach ensures optimal synthesis results while building a knowledge base of effective strategies.

The synthesis mechanism supports multiple operation modes including synchronous operation for immediate response requirements, asynchronous operation for background synthesis and cache optimization, and hybrid operation for progressive refinement of synthesized thoughts. This flexibility allows the system to balance response time requirements with synthesis quality needs. Through these synthesis mechanisms, the system can effectively combine and evolve cached thoughts to address new prompts without always requiring the computational overhead of the large language model, while maintaining the quality and relevance of generated responses.

Once T₁ is created, it is combined with the original prompt to form P+T₁ 2220, which is then processed by the smaller language model 2140 to generate the final response 2150. The newly synthesized T₁ is also routed back through the controller for potential caching with thought cache 2170, allowing it to be used for future similar prompts.

In one embodiment, thought cache 2170 provides performance improvements by eliminating redundant reasoning computations across similar prompts. When 2110 router identifies a new prompt with reasoning requirements similar to previously processed queries, thought cache 2170 can supply validated thought patterns rather than requiring the large language model to reconstruct the reasoning chain from scratch. This caching mechanism is particularly effective for common analytical patterns, such as mathematical derivations, logical deductions, or standard analytical frameworks that appear frequently across different prompts.

Additionally, thought cache 2170 is capable of serving as a quality assurance mechanism by maintaining verified reasoning patterns. Once a thought sequence has been validated and demonstrates consistent success in generating accurate responses, that sequence becomes a trusted template for handling similar queries. For instance, when processing mathematical problems, the cache may contain verified proof structures that can be applied to new problems within the same class, ensuring consistent and reliable solution approaches.

In one embodiment, thought cache 2170 implements a validation scoring system that tracks the success rate and reliability of each cached thought. This scoring considers factors such as but not limited to response accuracy, user feedback, and consistency with known truth standards. Thoughts that consistently contribute to high-quality responses receive higher validation scores, making them more likely to be selected for reuse in similar contexts. The cache can also mark certain thoughts as “golden” references when they demonstrate exceptional reliability in specific domains, establishing them as preferred reasoning patterns for their respective problem types.

To prevent the propagation of incorrect reasoning, thought cache 2170 may employ a

continuous validation mechanism. This mechanism monitors the performance of cached thoughts and can automatically flag patterns that lead to inconsistent or incorrect responses. When potential issues are detected, thought cache 2170 may temporarily suspend the use of problematic thoughts and route similar prompts through the large language model for fresh analysis. This self-correction capability ensures that the efficiency benefits of thought caching do not come at the expense of response quality.

Thought cache 2170 is capable of supporting selective thought inheritance, where new prompts can partially inherit validated reasoning patterns while allowing for context-specific modifications. This flexibility enables the system to leverage proven reasoning frameworks while adapting them to specific query requirements, combining the benefits of cached reliability with contextual relevance. Through these mechanisms, the thought cache achieves both performance optimization and quality enhancement, delivering faster responses while maintaining or improving the reliability of the system's outputs.

Through this synthesis process, the system can effectively leverage partially relevant cached thoughts to create more precise and relevant thoughts for the current prompt, reducing the need to engage the large language model while still maintaining response quality and relevance.

In another embodiment, thought cache 2170 implements security and privacy controls to protect sensitive information while enabling efficient thought reuse. At the storage level, thought cache 2170 maintains isolation between user contexts through encrypted partitioning. Each user's thoughts are encrypted with user-specific keys, ensuring that even within shared cache infrastructure, thoughts remain securely compartmentalized. This encryption extends to both the thought content and the associated metadata, preventing unauthorized access to reasoning patterns that might reveal proprietary information.

In the embodiment, thought cache 2170 implements a permissions framework that governs thought sharing and reuse. By default, thoughts derived from user interactions are marked private and restricted to the originating user's context. Users can optionally designate specific thoughts for shared use through explicit consent mechanisms. When thoughts are marked for sharing, the cache employs automated sanitization processes that strip personally identifiable information and sensitive data while preserving the underlying reasoning patterns. This sanitization uses advanced pattern recognition to identify and remove context-specific details while maintaining the thought's utility for general reasoning.

To protect against cache poisoning attacks, thought cache 2170 may incorporate a multi-stage validation pipeline. Before any thought is cached, it undergoes verification through a separate validation model that assesses its logical consistency and checks for potential malicious patterns. The cache maintains cryptographic checksums of validated thoughts, enabling rapid verification of thought integrity during retrieval operations. Additionally, the cache tracks the provenance of each thought, maintaining secure audit trails of thought creation, modification, and usage patterns.

The system implements graduated access controls that can restrict thought reuse based on security clearance levels, organizational boundaries, or specific sharing agreements. These controls allow enterprises to maintain separate thought caches for different security domains while selectively enabling thought sharing under controlled conditions. For instance, a financial institution might maintain separate caches for public customer service interactions and privileged internal analyses, with strict controls governing any cross-domain thought utilization.

Through these security mechanisms, the thought cache enables efficient reasoning reuse while protecting sensitive information and maintaining system integrity. The combination of encryption, access controls, and validation processes ensures that the performance benefits of thought caching do not compromise security or privacy requirements.

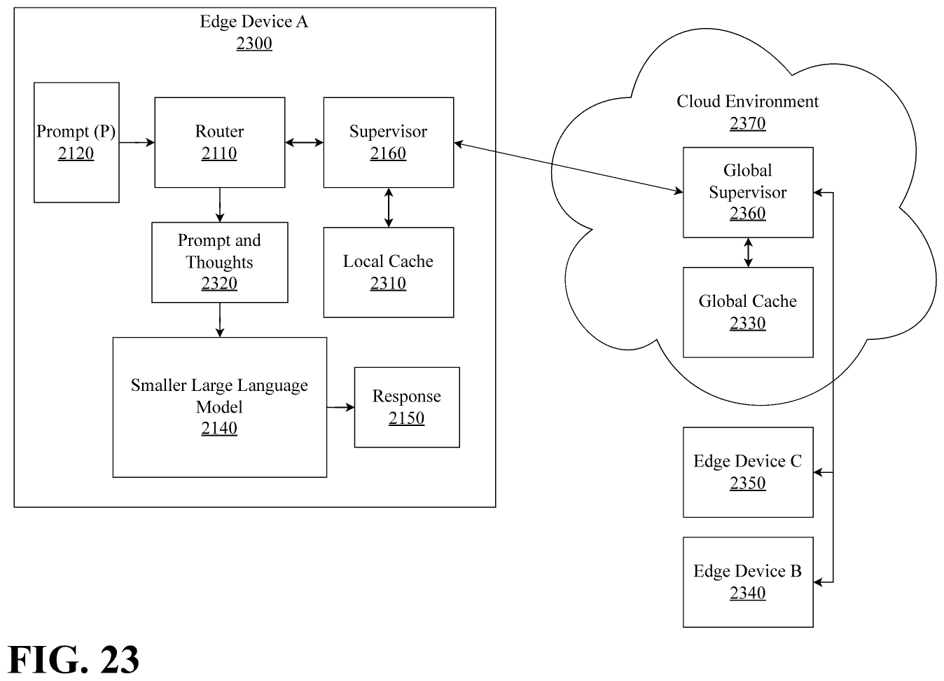

FIG. 23 is a block diagram illustrating an exemplary system architecture for a multi-state LLM with unlimited context with local and global thought caches. This embodiment demonstrates how the system can operate primarily on edge devices while maintaining access to a broader knowledge base through cloud connectivity.

Edge device A 2300 represents a complete edge implementation of the system, which could be a device such as but not limited to a mobile phone, tablet, or other personal computing device. Within the edge device 2300, router 2110 receives prompts (P) 2220 and coordinates with a local controller 2160 and local cache 2310. Local cache 2310 stores frequently accessed or personally relevant thoughts directly on the device, enabling quick access and offline functionality.

The smaller language model 2140 runs directly on the edge device, processing prompt and thought combinations 2320 to generate responses 2150. This local processing capability significantly reduces latency and computational requirements compared to constantly accessing cloud resources.

The cloud environment 2370 contains a global cache 2330 managed by a global controller 2360. This global infrastructure serves as a centralized repository for thoughts generated across multiple edge devices (B 2340, C 2350). The global controller coordinates cache synchronization and manages access patterns across the network of connected devices.

When an edge device's controller 2160 cannot find relevant thoughts in its local cache 510, it can query the global controller 2360 to search the global cache 2330. For example, if a user on edge device A 2300 asks a question about a topic they haven't encountered before, the system first checks the local cache 2310, then can reach out to the global cache 2330 for relevant thoughts.

The system supports bi-directional synchronization, where new thoughts generated on edge devices can be uploaded to the global cache, and frequently accessed global thoughts can be downloaded to local caches. This creates a dynamic knowledge-sharing environment while maintaining efficient local operation.

Through this architecture, the system provides the benefits of edge computing (low latency, offline capability, privacy) while maintaining access to a broader knowledge base through the cloud infrastructure. The distributed nature of the system allows for efficient scaling and knowledge sharing across user communities while minimizing the computational load on individual devices.

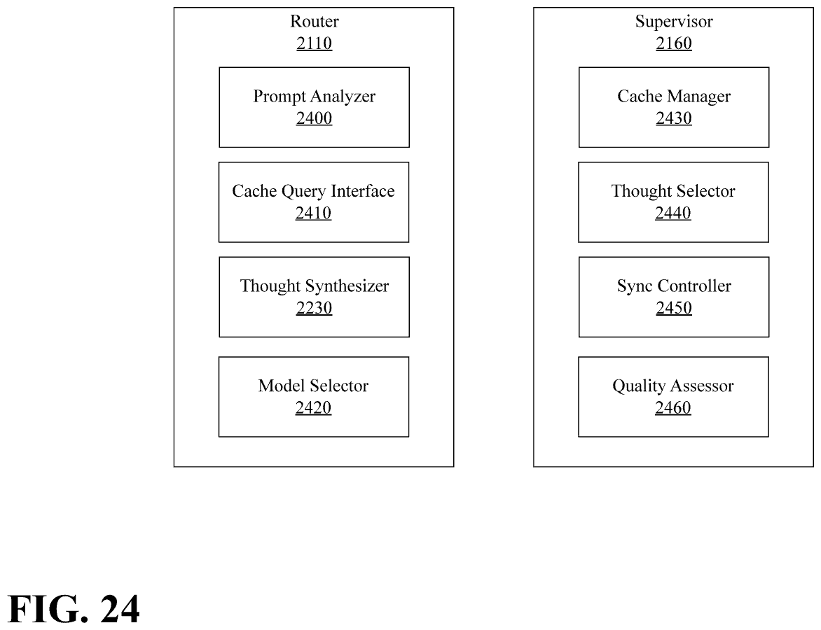

FIG. 24 is a block diagram illustrating exemplary components for a multi-state LLM with unlimited context, a router and a controller. A prompt analyzer 2400 processes incoming prompts to determine their characteristics, domain, and requirements. For example, if a user submits a prompt about quantum computing, the analyzer identifies key technical terms, determines the complexity level, and flags specific concepts that may need specialized thoughts. It also evaluates whether the prompt requires reasoning about multiple concepts (like quantum computing and machine learning) that might benefit from thought synthesis. Analyzer 2400 employs natural language processing to break down the prompt into component parts, identifying primary topics, subtopics, relationships between concepts, required depth of knowledge, and any constraints or special requirements specified in the prompt. It can also detect the tone and style of the desired response, technical sophistication level of the user, and whether the prompt requires factual recall, analytical reasoning, or creative synthesis.

A cache query interface 2410 serves as the communication bridge between the router and cache systems. It formats prompt analysis results into efficient cache queries and manages the retrieval process. For instance, when searching for thoughts about quantum computing, it might query both technical definition thoughts and practical application thoughts, managing multiple parallel cache requests to both local and global caches. The interface optimizes query patterns based on the analyzer's output, constructing sophisticated search parameters that account for concept hierarchies, semantic relationships, and contextual relevance. It can prioritize different aspects of the query based on importance, manage query timeouts and fallbacks, and handle distributed cache architectures efficiently. The interface also implements caching strategies to optimize frequent queries and manages cache coherence between local and global storage.

A model selector 2420 makes intelligent decisions about model utilization based on cache results and prompt analysis. It implements decision logic to determine whether to: use the large model for new thought generation, proceed with cached thoughts through the smaller model, or employ a hybrid approach. For example, if highly relevant thoughts exist in the cache, it might bypass the large model entirely to save computational resources. In one embodiment, model selector 2420 employs decision trees and heuristics that consider multiple factors including thought relevance scores, computational resource availability, response time requirements, and quality thresholds. It can dynamically adjust its selection criteria based on system load, cache hit rates, and historical performance metrics. Model selector 2420 also maintains statistics about the effectiveness of its decisions to continuously refine its selection strategy and may implement different selection policies based on user preferences or application requirements.

A cache manager 2430 handles the organization, storage, and retrieval of thoughts in both local and global caches. It implements indexing strategies for quick thought retrieval and manages cache memory efficiently. For example, it might maintain separate indices for different knowledge domains or implement priority-based storage systems where frequently accessed thoughts are kept in faster memory. Cache manager 2430 implements eviction policies to optimize cache utilization, considering factors such as but not limited to thought frequency of use, recency, size, and interdependencies with other cached thoughts. It also handles cache coherence between local and global stores, implements versioning and conflict resolution for distributed caches, and maintains metadata about cache performance and utilization patterns. The manager can dynamically adjust its caching strategies based on usage patterns and system resources, potentially implementing different policies for different types of thoughts or knowledge domains.

A thought selector 2440 implements algorithms to identify and select the most relevant thoughts from the cache. It uses similarity metrics and relevance scoring to rank cached thoughts based on their applicability to the current prompt. For instance, when processing a prompt about quantum computing applications in cryptography, it might prioritize thoughts that bridge both quantum and cryptographic concepts. Thought selector 2440 may employ multiple ranking algorithms that consider various aspects of thought relevance, including semantic similarity, contextual appropriateness, freshness, and historical success rates. It can perform multi-stage selection processes, first identifying broadly relevant thoughts and then refining the selection based on more specific criteria. The selector also considers relationships between thoughts, potentially selecting groups of related thoughts that together provide comprehensive coverage of the prompt's requirements. It maintains performance metrics about selection accuracy and can adapt its selection criteria based on feedback about the effectiveness of selected thoughts in generating successful responses.

A sync controller 2450 manages the complex task of synchronizing thoughts between

local and global caches. It implements policies for when to upload local thoughts to the global cache and when to download global thoughts to local storage. For example, it might upload locally generated thoughts about emerging technologies to the global cache while downloading commonly accessed thoughts about fundamental concepts to local storage. Sync controller 2450 may employ synchronization strategies that balance network bandwidth usage, storage constraints, and data freshness requirements. It implements conflict resolution mechanisms for handling simultaneous updates, version control for tracking thought evolution, and differential synchronization to minimize data transfer. Sync controller 2450 can adapt its sync frequency and policies based on usage patterns, network conditions, and device capabilities. It also maintains detailed synchronization logs and metrics to optimize future sync operations and implements recovery mechanisms for handling failed synchronization attempts. Additionally, sync controller 650 can prioritize synchronization tasks based on thought importance, urgency, and resource availability.

A quality assessor 2460 continuously evaluates thought quality and usefulness. It monitors factors such as thought relevance, accuracy, and usage patterns to maintain cache quality. For example, if certain thoughts consistently lead to high-quality responses (as measured by user feedback or other metrics), they might be prioritized for retention and synchronization. Conversely, thoughts that rarely prove useful might be flagged for removal or update. Quality assessor 2460 may employ multiple evaluation criteria including syntactic correctness, semantic coherence, factual accuracy, and practical utility. It maintains historical performance metrics for each thought, tracking success rates in different contexts and user satisfaction levels. Quality assessor 2460 can detect outdated or inconsistent thoughts, identify redundant thoughts that could be merged, and flag thoughts that may need revision due to changing knowledge or requirements. It implements adaptive quality thresholds that can vary based on thought domain, importance, and usage context. Quality assessor 2460 also provides detailed quality reports that can be used to guide cache maintenance operations and thought synthesis decisions, and it can trigger automatic thought improvement processes when quality metrics fall below acceptable thresholds.

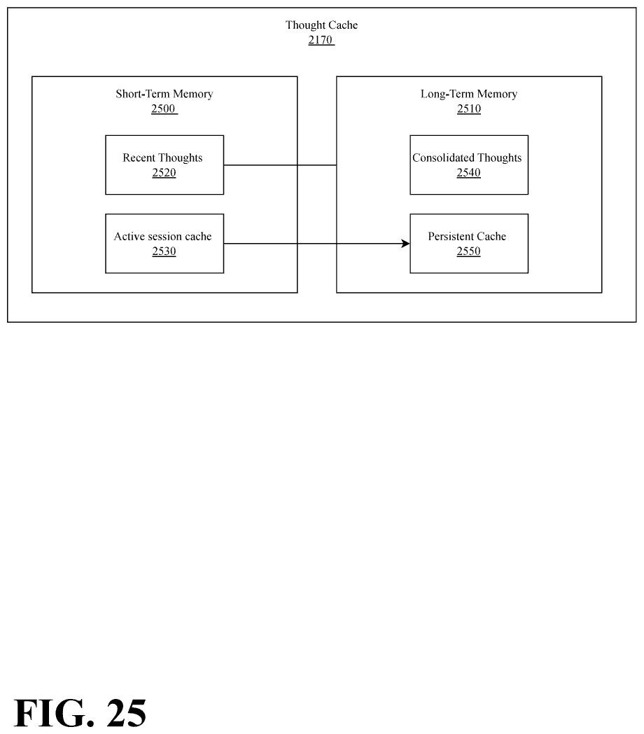

FIG. 25 is a block diagram illustrating an exemplary system architecture of a thought cache that has both a long-term memory and a short-term memory. In one embodiment, thought cache 2170 represents a system for maintaining effectively unlimited context in language models through progressive compression and intelligent caching of thought patterns, enabling shared reasoning across multiple AI instances.

Thought cache 2170 implements both a short-term memory 2500 and a long-term memory 2510. This dual-memory architecture enables the system to maintain both immediate computational context and historical reasoning patterns while managing computational resources efficiently.

The short-term memory 2500 comprises recent thoughts 2520 and an active session cache 2530. Recent thoughts 2520 maintain complete thought fidelity, storing both the explicit reasoning chains and the internal model states that generated them. This storage preserves not only the textual representation of thoughts but also the computational context and attention patterns that produced them, enabling precise replication of reasoning processes. The active session cache 2530 provides rapid access to these thoughts and their associated states, optimizing performance for ongoing interactions and enabling immediate thought sharing between different AI instances or specialized reasoning modules operating within the same session.

The long-term memory 2510 implements a more sophisticated storage approach through consolidated thoughts 2540 and a persistent cache 2550. Consolidated thoughts 2540 represent progressively compressed versions of thought patterns, where multiple related thoughts are combined into more compact representations while preserving essential reasoning patterns. This consolidation process employs various compression techniques, including attention-based compression, semantic clustering, and state space reduction. The persistent cache 2550 implements an indexed storage system that enables semantic search and retrieval of these consolidated thoughts, supporting efficient thought sharing across different Al instances and computing sessions.

The system implements bidirectional information flow between these components. Thoughts can move from recent thoughts 2520 to consolidated thoughts 2540 through progressive compression, while the active session cache 2530 can transfer frequently accessed patterns to the persistent cache 2550 for long-term retention. This bidirectional flow enables dynamic thought sharing between different system components and AI instances, supporting collaborative reasoning across multiple agents.

The architecture supports multiple implementation approaches for thought storage and transfer. Thoughts can be stored as chain-of-thought text, internal model states, attention patterns, or hybrid representations combining multiple formats. The system can dynamically select the most appropriate storage format based on the thought's intended use and the capabilities of the AI instances that may access it.

This architectural design enables the thought cache to serve as a central memory system for multiple AI instances, supporting collaborative reasoning while maintaining computational efficiency. The combination of short-term and long-term memory systems, along with progressive compression and flexible thought representation, allows the system to maintain effectively unlimited context while enabling efficient thought sharing across different Al agents and reasoning modules.

Through this architecture, the system achieves both unbounded context maintenance and efficient cross-instance thought sharing, two key innovations that enable more sophisticated and resource-efficient Al reasoning systems. The design's flexibility in implementation approaches and storage formats helps prevent trivial circumvention while enabling broad application across different types of language models and AI systems.

In one embodiment the system implements a collaborative thought sharing architecture that enables multiple AI agents to access and utilize a common thought cache. This shared cache architecture supports distributed reasoning across different types of language models and specialized reasoning modules while maintaining thought consistency and accessibility. When multiple users or Al agents operate within the system, they can all contribute to and benefit from the accumulated reasoning patterns stored in the shared cache.

The shared thought cache maintains a unified index that enables any authorized user or AI agent to access relevant thoughts regardless of which agent originally generated them. This indexing system tracks not only the content of thoughts but also their originating context, generating agent, and successful usage patterns. For example, when a specialized mathematical reasoning module generates a thought containing a proof strategy, that thought becomes available to general language models handling related mathematical queries, enabling them to leverage expert reasoning patterns without duplicating the computational effort.

Thought transfer between specialized reasoning modules occurs through a standardized thought protocol. This protocol defines how thoughts are packaged, transmitted, and unpacked between different types of AI agents. When transferring thoughts, the system includes not just the reasoning content but also relevant metadata such as the thought's context requirements, assumptions, and compatibility markers. For instance, if a natural language processing agent generates insights about sentence structure, these thoughts can be transferred to a grammar checking module in a format that preserves the structural analysis while adapting it to the specialized module's processing requirements.

The system coordinates collaborative reasoning through a central orchestration mechanism. This orchestrator tracks which agents are actively processing related prompts and manages the flow of thoughts between them. When multiple agents encounter similar reasoning requirements, the orchestrator can initiate thought sharing to prevent redundant computation. For example, if one agent has already performed detailed analysis of a complex concept, other agents can build upon that analysis rather than repeating it.

Cross-instance reasoning is enabled through thought synthesis capabilities. When different model instances approach similar problems from different angles, their thoughts can be combined to create more comprehensive understanding. The system tracks the complementary strengths of different model instances and can route thoughts to the most appropriate agent for specific types of reasoning tasks. For instance, a general language model might handle initial prompt analysis, while specialized agents process domain-specific aspects, with their combined thoughts contributing to the final response.

The shared cache implements sophisticated access control and version management to maintain thought integrity across multiple agents. Each thought is versioned to track its evolution as different agents interact with and build upon it. The system maintains provenance information that records how thoughts are transformed and combined through multi-agent collaboration, enabling attribution and quality assessment of collaborative reasoning patterns.

Through these mechanisms, the system enables efficient distribution of reasoning tasks across specialized modules while maintaining coherent thought flow. The collaborative architecture allows different AI agents to contribute their specialized capabilities while benefiting from the collective reasoning capacity of the system. This approach significantly reduces computational redundancy while enabling more sophisticated reasoning through the combination of multiple specialized perspectives.

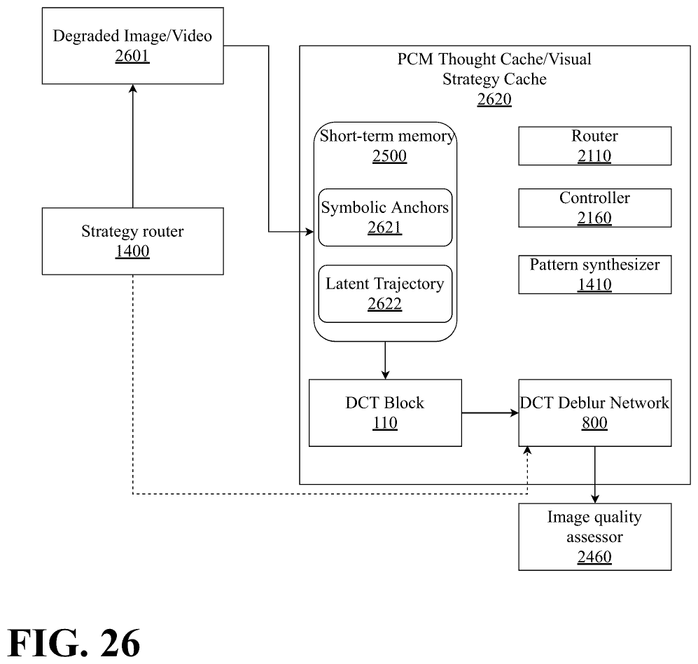

FIG. 26 is a block diagram illustrating an exemplary system architecture that integrates Persistent Cognitive Machine (PCM) memory framework with a real-time image and video processing pipeline. The system is configured to process degraded image or video inputs—such as those affected by motion blur, low-light noise, or compression artifacts—using both traditional transform-domain techniques and an adaptive, memory-augmented visual strategy system. As shown in FIG. 26, the PCM-integrated architecture combines the visual strategy cache 2620 with the degraded input processing pipeline, enabling cognitive memory-driven enhancement.

As shown in FIG. 26, a degraded image or video input 2601 is received by a strategy router 1400, which performs initial degradation analysis. The system extracts a degradation fingerprint—a structured, feature-rich representation of the image's perceptual artifacts—and projects it into a Lorentzian latent space. This latent fingerprint is then used to query the PCM thought cache and visual strategy cache 2620, which serves as a unified cognitive memory system designed to store, retrieve, and update image enhancement strategies encoded as latent geodesic trajectories.

The PCM thought cache 2620 includes multiple memory layers and control modules. A short-term memory region 2500 (also called local thoughts) stores recently applied and session-specific strategies, which may be further indexed using symbolic anchors 2621—semantic labels linked to specific trajectory points (e.g., “motion blur,” “low-light,” or “artifact edge jitter”). Below this, latent trajectories 2622 represent the compressed geodesic paths through latent space that encode prior corrective strategies. These memory elements are coordinated by a suite of cognitive coordination modules, including a router 2110, controller 2160 and pattern synthesizer 1410, all responsible for performing symbolic lookups, trajectory comparison, and strategy synthesis.

When a degradation fingerprint matches an existing latent trajectory above a predefined similarity threshold, the PCM thought cache returns optimized parameters for processing. These parameters may be used to bypass the standard DCT path and configure the DCT Deblur Network directly—representing a fast-path retrieval. If no match is found, the system proceeds along a conventional route: the degraded input is first passed through a DCT Block 110, which decomposes the signal into subband images, and then routed to the DCT Deblur network 800 for transform-domain processing. The network handles AC (high-frequency detail) and DC (low-frequency structure) either separately or jointly, depending on configuration.

The output from the DCT Deblur network 800 is assessed by the image quality assessor 2460, which computes both conventional image metrics (e.g., PSNR, SSIM, perceptual loss) and latent-space metrics such as compression pressure—a scalar reflecting semantic density or saliency in the visual manifold. These quality metrics are fed back into the PCM controller and strategy router to inform future strategy synthesis, promotion, and cache evolution.

If evaluated strategy meets or exceeds defined quality thresholds, it is archived in the PCM thought cache 2620. The archived data includes the degradation fingerprint, compression pressure map, symbolic metadata, and the latent trajectory of the strategy itself. This feedback loop enables memory expansion and strategic densification, allowing the system to handle new degradations with increasing efficiency.

In some embodiments, the visual strategy cache described in FIG. 26 is implemented as a domain-specific instantiation of the Thought Cache 2170 described in FIG. 21. The PCM Thought Cache is architected to store and organize context-dependent knowledge structures—referred to as “thoughts”—across a variety of modalities. In the present embodiment, thoughts corresponding to visual degradation fingerprints, subband image patterns, and DCT deblurring strategies are stored in the same persistent cognitive memory system, indexed alongside or interleaved with symbolic thoughts from other domains such as language modeling or object recognition. Thus, the visual strategy cache forms an integral subset of the unified PCM Thought Cache, enabling cross modal reasoning, caching, and synthesis within a single cognitive memory framework.

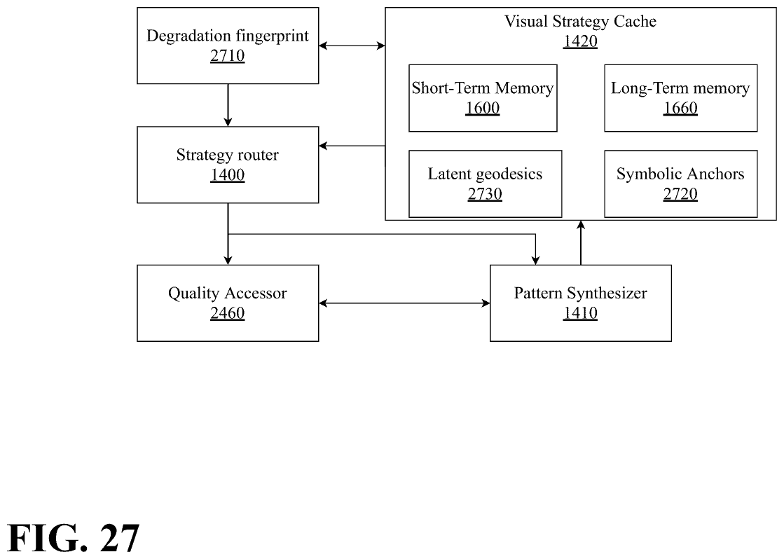

FIG. 27 is a block diagram of an exemplary architecture for a hierarchical visual strategy cache system designed according to Persistent Cognitive Machine (PCM) memory principles. This intelligent caching system enables adaptive, learning-based visual processing through structured latent memory, symbolic indexing, and geodesic-based strategy synthesis. The architecture supports both exact and approximate strategy retrieval via latent similarity queries, enabling more flexible and semantically meaningful reuse.

The visual strategy cache 1420 employs a two-tier memory hierarchy optimized for different temporal scopes and cognitive functions. The Short-Term Memory tier 1600 stores session-specific strategy information, including degradation fingerprints encountered during active sessions and temporary adaptations created in response to local device conditions or recent patterns. This tier enables fast retrieval of high-confidence strategies and supports real-time responsiveness to recurring degradations. It also serves as an incubation space where effective strategies are promoted into long-term memory following quality validation.

The long-term memory tier 1660 consolidates visual strategies that have demonstrated

consistent effectiveness across sessions and devices. This tier stores meta-strategies, often formed through recombination of multiple successful approaches. It also supports frequency-aware pruning, automatically compressing or discarding rarely used or low-performing strategies to optimize memory capacity while preserving strategic diversity. Over time, this tier forms a dense lattice of latent geodesics, improving coverage of the degradation space and reducing future reliance on fallback processing.

The strategy router 1400 interfaces with both memory tiers. It receives degradation fingerprints extracted from incoming video or image data and performs latent similarity queries against the cache. These queries compare the input fingerprint's latent representation against cached geodesic trajectories using distance metrics or semantic curvature scores. In addition to direct retrieval, the Strategy Router evaluates whether retrieved strategies should be applied as-is, adapted with minor modification, or escalated to synthesis based on current conditions and compression pressure. If no suitable strategy meets the relevance threshold, the router triggers the synthesis pathway.

The pattern synthesizer 1410 operates as the cache's cognitive composition engine. It combines multiple cached strategies—each represented as a latent trajectory—into a single, synthesized geodesic. This process enables the system to create semantically coherent restoration pathways when presented with compound or previously unseen degradation profiles. The synthesis mechanism allows the system to “fill in” gaps in the strategic manifold, resulting in higher future hit rates even for unfamiliar inputs. The resulting synthesized strategies are validated and archived in the cache, contributing to the system's evolving strategic knowledge base.

The cache system is organized using symbolic anchors 2720 and latent geodesics 2730, enabling semantic relationships between strategies across both memory tiers. Symbolic anchors 2720 attach metadata or labels (e.g., “motion blur”, “low-light”, “JPEG artifact”) to specific geodesic paths. These anchors facilitate bi-directional retrieval, cross-modal reasoning, and integration with upstream symbolic reasoning components of the PCM. Latent geodesics 2730, meanwhile, encode the full trajectory of a visual strategy through Lorentzian latent space—supporting both reuse and interpolation. Geodesic structure allows for efficient memory traversal, blending, and expansion in a cognitively meaningful manner.

The quality assessor 2460 continuously monitors the effectiveness of retrieved and synthesized strategies. It computes traditional image quality metrics such as PSNR, SSIM, and perceptual loss, as well as compression pressure, which measures semantic density and cognitive saliency within the latent representation. Based on these evaluations, the Quality Assessor 2460 promotes high-performing short-term strategies to long-term memory and flags underperforming entries for pruning. This closed-loop evaluation system improves strategic precision while increasing the effective cache hit rate over time.

This hierarchical, latent-memory architecture transforms the system into a self-improving cognitive agent for visual processing. Strategy application is informed not only by immediate input characteristics but also by accumulated experiential knowledge and latent similarity across degradations, consistent with the cognitive geometry principles described in the parent application 47048FT. By recombining symbolic anchoring, geodesic memory structures, and adaptive retrieval, the system delivers increasingly effective and efficient performance in the face of complex, evolving visual challenges.

In one embodiment, each visual strategy is represented as a discrete geodesic path in a 512-dimensional Lorentzian latent space. The geodesic trajectory is defined mathematically as a sequence of latent embedding vectors {z₁, z₂, . . . , zₙ} where each zᵢ∈ [symbol] represents a waypoint in the strategy's evolution from initial degradation state to corrected output state.

In Lorentzian metric tensor is defined as G_μv=diag(−1, 1, 1, . . . , 1), where the first component represents a temporal-like dimension and the remaining 511 components are spatial-like. The geodesic distance between any two points z₁ and z₂ is computed using the formula: d_geo(z₁,z₂)=arccosh(−G(z₁,z₂)) where G(z₁,z₂)=−z₁⁰z₂⁰+Σᵢ₌₁⁵¹¹z₁ⱼz₂ⱼ.

Trajectory generation begins with strategy parameter vectorization. All DCT deblur network parameters, including convolution kernel weights W∈ [symbol] , bias terms b∈ [symbol] , and processing sequence indicators, are concatenated into a high-dimensional parameter vector P∈ [symbol] where D typically ranges from 10,000 to 50,000 parameters depending on network complexity.

The parameter vector P is projected into the 512-dimensional latent space using a learned encoder network E: [symbol] → [symbol] . The encoder comprises three fully-connected layers with architectures [D→2048→1024→512], using ReLU activations and dropout regularization (p=0.3). The encoding function is defined as: z=E(P)=W₃·ReLU(W₂·ReLU(W₁·P+b₁)+b₂)+b₃ where Wᵢ and bᵢ represent the learned weight matrices and bias vectors for each layer.

Geodesic interpolation between strategies follows the Lorentzian analog of great circle paths. Given two strategy points z₁ and z₂, the geodesic curve γ(t) connecting them is computed as: γ(t)=cosh(td)z₁+sinh(td)v where d=d_geo(z₁,z₂) is the geodesic distance and v is the unit tangent vector at z₁ pointing toward z₂, calculated as: v=(z₂−z₁cosh(d))/sinh(d) The parameter t∈[0,1] represents proper time along the trajectory.

Each trajectory is discretized into N=20 equally-spaced waypoints using proper time intervals Δt=1/(N−1). The i-th waypoint is computed as zᵢ=γ(iΔt). Storage requirements are optimized through principal component analysis, retaining 256 dimensions that preserve 95% of the original trajectory variance, reducing storage from 10.24 KB to 5.12 KB per trajectory.

Symbolic anchors are automatically attached to trajectory waypoints exhibiting high semantic curvature. The local curvature κ(t) at each point is computed using the formula: κ(t)=∥d²γ/dt²∥/(1+∥dγ/dt∥²)\hat{ }(3/2) Waypoints where κ(t)>κ_threshold (typically 0.1) are marked as anchor candidates. A learned attention mechanism then assigns semantic labels such as “motion_blur_detection,” “edge_enhancement,” or “noise_reduction” to these high-curvature points.

During strategy retrieval, similarity matching employs both Euclidean and geodesic distance metrics. For a query degradation fingerprint f_query, the system computes similarity scores against cached trajectories using: similarity(f_query, trajectory_i)=exp(−d_geo(E(f_query), z_i\hat{ }start)) where z_i\hat{ }start represents the initial waypoint of trajectory_i and E(f_query) is the encoded query fingerprint.

Strategy synthesis combines multiple trajectories through weighted geodesic averaging. Given k relevant trajectories {γ¹, γ²} with similarity weights {w₁, w₂, . . . , wₖ}, the synthesized trajectory γ_synth(t) is computed as: γ_synth(t)=normalize(Σᵢ₌₁^{k}wᵢγⁱ(t)) where normalize( ) ensures the result lies on the Lorentzian manifold by adjusting the temporal component to maintain the metric constraint G(γ_synth, γ_synth)=−1.

Cross-modal strategy transfer demonstrates the power of the unified PCM architecture. Consider a scenario where the system has learned effective edge-preserving denoising strategies for visual processing. When subsequently processing natural language text with corrupted character boundaries (analogous to “edges” in text), the system can adapt the edge-preservation principles to maintain word boundaries while correcting character-level errors.

Conversely, sequential reasoning patterns learned in language processing can enhance visual processing workflows. For instance, if the system learns a effective multi-step reasoning strategy for solving mathematical word problems (hypothesis formation→validation→refinement), this same sequential pattern can be applied to iterative image enhancement (degradation assessment→correction→quality evaluation→refinement).

The shared memory architecture enables efficient knowledge transfer. A strategy learned for detecting motion blur in video sequences (characterized by directional frequency attenuation) can inform detection of temporal patterns in sequential text processing (characterized by directional dependency relationships). Both rely on similar mathematical principles of directional pattern analysis, enabling meaningful cross-domain strategy reuse.

### Detailed Description of Exemplary Aspects

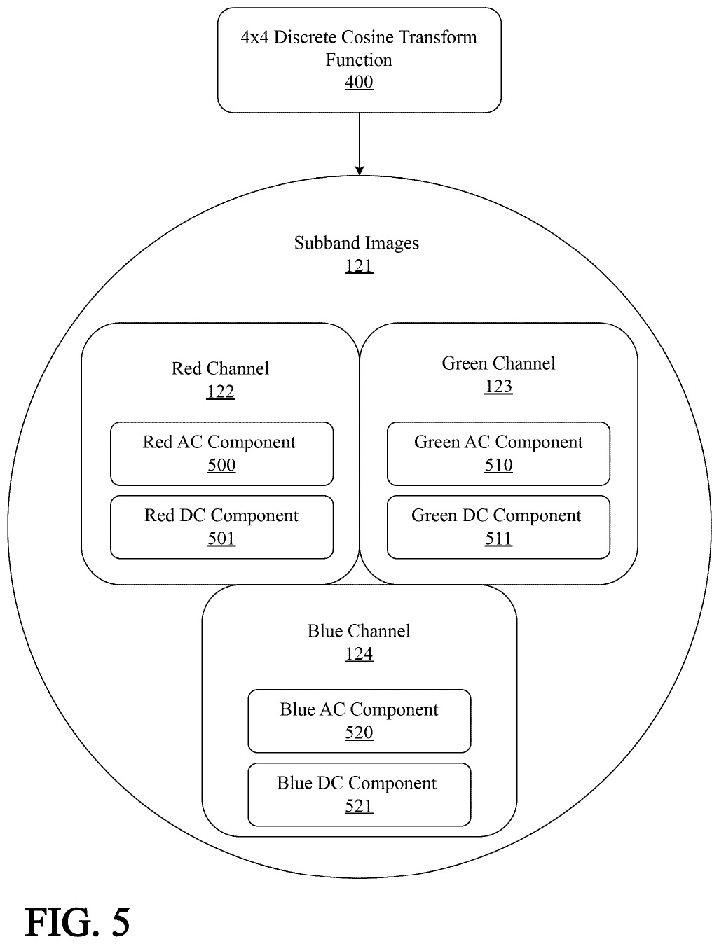

FIG. 5 is a diagram showing an embodiment where the subband images are comprised of three color components each further comprising an AC component and a DC component. The 4×4 Discrete Cosine Transform function 400 converts the degraded input into three sets of corresponding subband images 121. In one embodiment, there may be three sets of subband images, one for a red channel 122, one for a green channel 123, and one for a blue channel 124. Because a 4×4 Discrete Cosine Transform function 400 was used, the subband images 121 will have sixteen components comprising a plurality of AC and DC components. Each red, green, and blue channel will have corresponding AC and DC component. In one embodiment, the red channel 122 may have one red DC component 501 and fifteen red AC components 500. The green channel 123 may have one green DC component 510 and fifteen green AC components 511. Additionally, the blue channel 124 may have one blue DC component 520 and fifteen blue AC components 521. Each AC and DC component would subsequently be passed into the DCT Deblur Network channels.

As a concrete example, consider processing a motion-blurred image with horizontal blur kernel of length 7 pixels. The degradation fingerprint extraction yields f=[0.15, 0.82, −0.31, . . . , 0.06]∈ [symbol] . After encoding through E(f), this produces initial trajectory point z₀=[−0.89, 0.34, 0.12, . . . , 0.07]∈ [symbol] . The system queries cached trajectories and finds a match with geodesic distance d_geo=0.23, corresponding to a previously successful horizontal motion blur correction strategy. The cached trajectory waypoints z₁ through z₂₀ are retrieved and decoded back to DCT deblur network parameters, configuring the AC channel with enhanced horizontal frequency sensitivity.

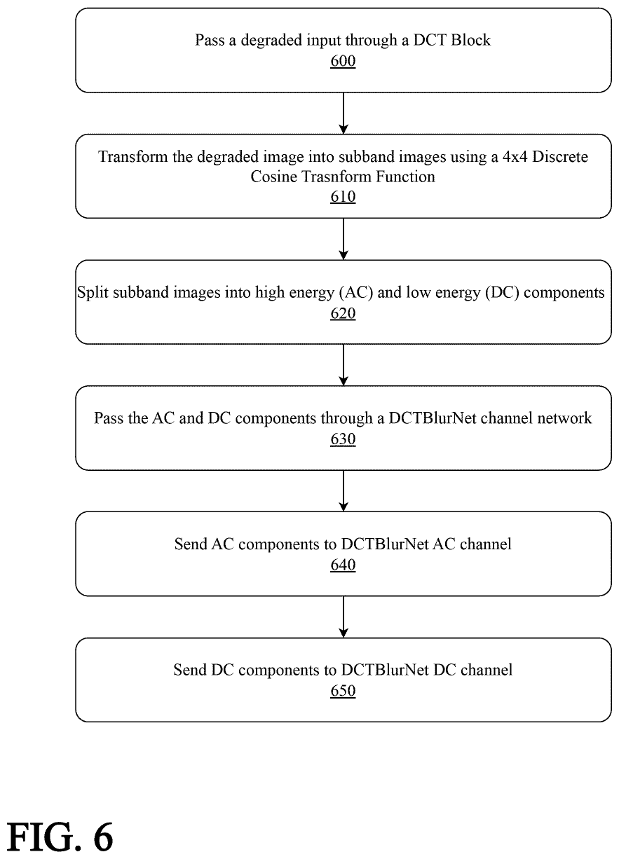

FIG. 6 is a flow diagram illustrating an exemplary method for image and video deconstruction, according to an embodiment. Regarding the steps in this diagram, there is no strict requirement for the steps to be in this particular order. In a first step 600, a degraded input is passed through a DCT block. In a step 610 the degraded image is transformed into subband images using a 4×4 Discrete Cosine Transform Function. In a step 620, the subband images are split into high energy (AC) and low energy (DC) components. In a step 630, the AC and DC components are passed through a DCT Deblur Network channel. In a step 640, the AC components are sent to a DCT Deblur Network AC channel. In a step 650, the DC components are sent to a DCT Deblur Network DC channel.

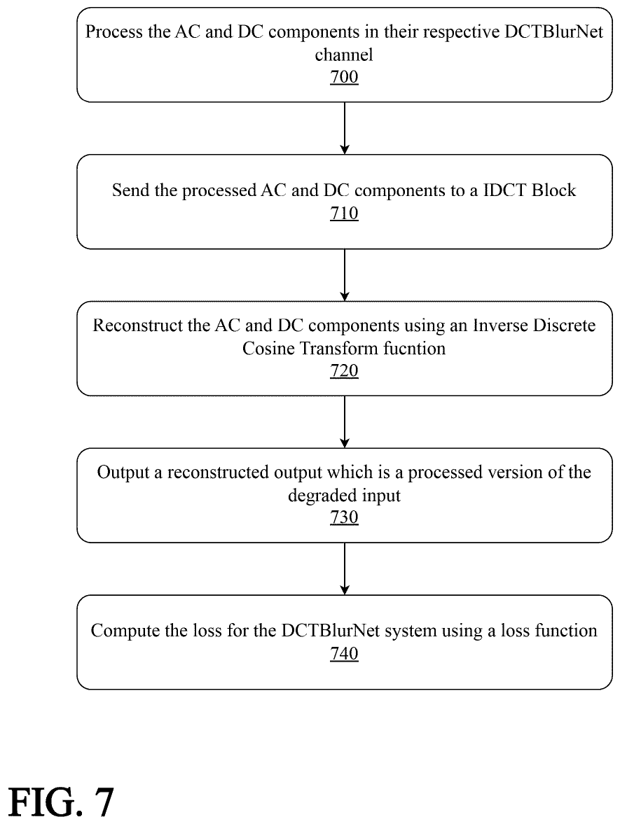

FIG. 7 is a flow diagram illustrating an exemplary method for image and video reconstruction, according to an embodiment. Regarding the steps in this diagram, there is no strict requirement for the steps to be in this particular order. In a first step 700, the AC and DC components are processed in their respective DCT Deblur Network channel. In a step 710 the processed AC and DC components are sent to an IDCT Block. In a step 720, the AC and DC components are reconstructed using an Inverse Discrete Cosine Transform function. In a step 730, the reconstructed output which is a processed version of the degraded input is output by the IDCT Block. In a step 740, a loss function computes the loss for the DCT Deblur Network channels. In one embodiment, an example of a loss function may be the following:

$${L}_{1} = {\sum }_{i = 1}^{N} ‖ {I}_{D C T} ( i ) - {\hat{I}}_{D C T} ( i ) ‖$$

Where Î_{DCT} is predicted DCT subband image, I_{DCT} is corresponding ground-truth DCT subband image, and N is the number of pixels. Since AC and DC networks may be trained separately, two loss functions may be used for AC and DC channels, where the DC network is only learning the DC subband images and the AC network is learning all the AC subband images.

The DCT Deblur Network is trained using paired data consisting of clean and synthetic degraded images. The training dataset includes 50,000 RGB image pairs, with degradations generated by applying motion blur 5×5 to 15×15 linear kernels), Gaussian blur (σ=0.5−2.0), and JPEG compression (quality 10-60). Data augmentation includes: “Random rotation (±15°),” scaling (0.8-1.2×),” and “Gaussian noise injection (σ=0.01−0.05).” The training uses the Adam optimizer with the following hyperparameters: “Learning rate: 0.001,” “Batch size: 32,” Epochs: 100.”

The DCT Deblur Network training follows a comprehensive multi-stage procedure designed for optimal convergence and generalization. The training pipeline begins with dataset preparation where clean images are corrupted using parametric degradation models: motion blur kernels generated using Gaussian-weighted line functions with lengths 5-15 pixels and orientations 0-359°, defocus blur created through disk convolution with radii 1.0-3.0 pixels, and JPEG compression applied at quality levels 15-75 using standard quantization tables. Each training batch contains 32 image pairs randomly sampled from the 50,000-pair dataset, with real-time augmentation applied: random horizontal/vertical flips (probability 0.5), rotation by angles sampled from uniform distribution [−15°, +15°], scaling factors from uniform distribution [0.8, 1.2], and additive Gaussian noise with σ sampled from [0.005, 0.025]. The forward pass processes images through the 4×4 DCT transformation: DCT_coeff[u,v]=(¼)×C(u)×C(v)×Σᵢ₌₀³Σⱼ₌₀³ pixel[i,j]×cos((2i+1)πu/8)×cos((2j+1)πv/8), where C(0)=1/√2 and C(n)=1 for n>0. The resulting 16 DCT coefficients per block are separated into DC (coefficient [0,0]) and AC components (remaining 15 coefficients) and processed through their respective networks. Loss computation uses L1 norm in DCT domain: L_DC=(1/N)×Σₙ|DCT_pred[n,0,0]−DCT_target[n,0,0]| and L_AC=( 1/15N)×πₙΣ_{u,v}≠₀|DCT_pred[n,u,v]−DCT_target[n,u,v]|, with total loss L_total=L_DC+λ_AC×L_AC where λ_AC=0.7. Optimization uses Adam with learning rate schedule: initial lr=0.001, reduced by factor 0.5 every 25 epochs, minimum lr=0.0001. Gradient clipping maintains stability with max_norm=1.0. Training proceeds for 100 epochs with early stopping when validation loss plateaus for 10 consecutive epochs. Model checkpointing saves best weights based on validation PSNR, and final model selection uses ensemble of top 3 checkpoints.

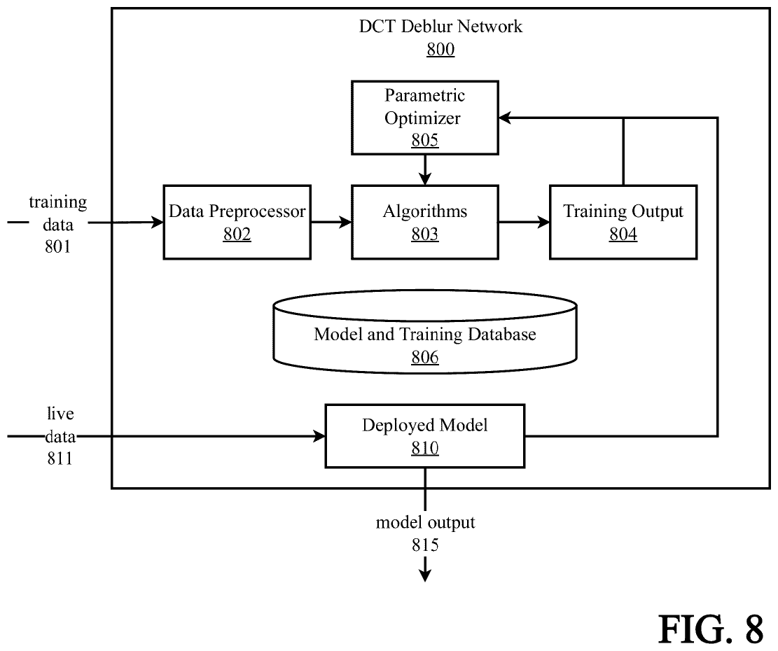

FIG. 8 is a block diagram illustrating an exemplary aspect of a system for image processing using a convolutional neural network, the DCT Deblur Network system 800. According to the embodiment, DCT Deblur Network system 800 may comprise a model training stage comprising a data preprocessor 802, one or more machine and/or deep learning algorithms 803, training output 804, and a parametric optimizer 805, and a model deployment stage comprising a deployed and fully trained model 810 configured to perform tasks described herein such as transcription, summarization, agent coaching, and agent guidance. DCT Deblur Network system 800 may be used to train and deploy DCT Deblur Network DC 130 and DCT Deblur Network AC 140 in order to support quality of the reconstructed output 160. FIG. 8 illustrates the complete DCT Deblur Network system 800 architecture used for both training and deployment phases of the neural network components.

At the model training stage, a plurality of training data 801 may be received by the DCT Deblur Network 800. In some embodiments, the plurality of training data may be obtained from one or more database(s) 806 and/or directly from the DCT block 110. Data preprocessor 802 may receive the input data and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 802 may also be configured to create training dataset, a validation dataset, and a test set from the plurality of input data 801. For example, a training dataset may comprise 80% of the preprocessed input data, the validation set 10%, and the test dataset may comprise the remaining 10% of the data. The preprocessed training dataset may be fed as input into one or more machine and/or deep learning algorithms 803 to train a predictive model for object monitoring and detection.

DCT Deblur Network 800 may be fine-tuned using a loss function which compares the predicted subband image against a ground-truth subband image. Fine-tuning involves adjusting the model's parameters to make it perform better on specific tasks or data. In this case, the goal is to improve the model's performance processing images and videos. The fine-tuned models are expected to provide improved accuracy when processing images and videos, which can be crucial for applications like deblurring images. The refined models can be optimized for real-time processing, meaning they can quickly analyze and process an image or video as soon as they are input into the system.

During model training, training output 404 is produced and used to measure the accuracy and usefulness of the predictive outputs. During this process a parametric optimizer 805 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

A model and training database 806 is present and configured to store training/test datasets and developed models. Database 806 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 803 may comprise a deep learning algorithm such as neural networks (e.g., recurrent, convolutional, long short-term memory networks, etc.).

In some implementations, the DCT Deblur Network 800 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database 810.

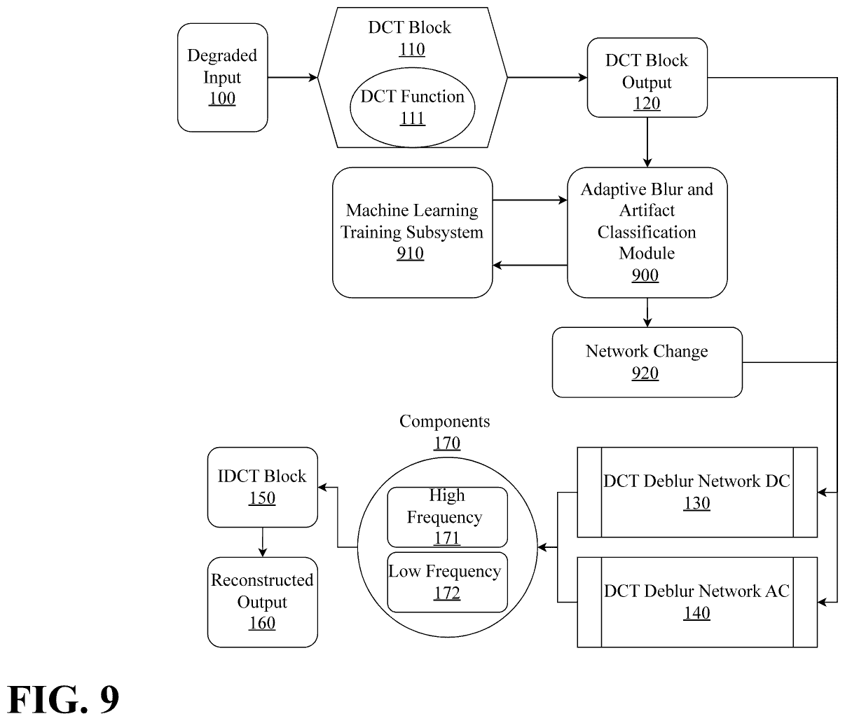

FIG. 9 is a block diagram illustrating an exemplary system architecture for adaptive real time discrete cosine transform image and video processing with convolutional neural network architecture, according to an embodiment. In one embodiment, the system may include an adaptive blur and artifact classification module 900. This module is positioned between DCT block output 120 and DCT deblur network channels 130 and 140, allowing the adaptive blur and artifact classification module 900 to analyze the transformed image data before it undergoes deblurring. The adaptive blur and artifact classification module 900 may employ machine learning techniques to identify and categorize various types of blur and compression artifacts present in the input image or video frame.

Upon receiving the DCT block output, adaptive blur and artifact classification module 900 performs a rapid analysis of the subband images. It extracts features that are indicative of different types of degradation, such as motion blur, defocus blur, or compression artifacts like blocking or ringing. These features might include statistical measures of the frequency components, edge characteristics, or texture patterns. The module then uses its trained classification model to determine the predominant types and severity of degradation present in the current frame.

A machine learning training subsystem 910 trains the adaptive blur and artifact classification module 900. This subsystem may train adaptive blur and artifact classification module 900 initially, or over time while the system operates, continuously refining the classification model based on new data and feedback from the system's performance. For example, if the system encounters a new type of artifact that it struggles to classify accurately, the machine learning training subsystem can incorporate this new data into its training set, update the model, and improve future classifications.

A network change component 920 acts as the bridge between the classification results and the DCT deblur networks. Based on the output from adaptive blur and artifact classification module 900, the network change component dynamically adjusts the parameters and processing strategies of both the DC and AC deblur networks 130 and 140. For instance, if the classification module 900 determines that the current frame primarily suffers from motion blur, the network change component might instruct the AC deblur network 140 to focus more heavily on horizontal frequency components, which are typically more affected by motion blur.

These new components work in concert to create a more adaptive and efficient image processing system. As an example of their operation, consider a video stream where the scenes rapidly switch between a fast-moving sports event and a static interview. Adaptive blur and artifact classification module 900 would quickly identify the changing blur characteristics between these scenes. For the sports footage, it might detect motion blur and instruct the network change component to optimize the deblur networks for motion compensation. When the scene changes to the static interview, the module might instead detect compression artifacts, prompting a different set of optimizations focused on reducing blocking and ringing effects.

The integration of these components allows the system to handle a wide variety of image degradations more effectively than a static system could. By continuously adapting its processing strategy to the specific characteristics of each input frame, the system can produce higher quality output across a broader range of real-world scenarios, from high-motion video to compressed still images, all in real-time.

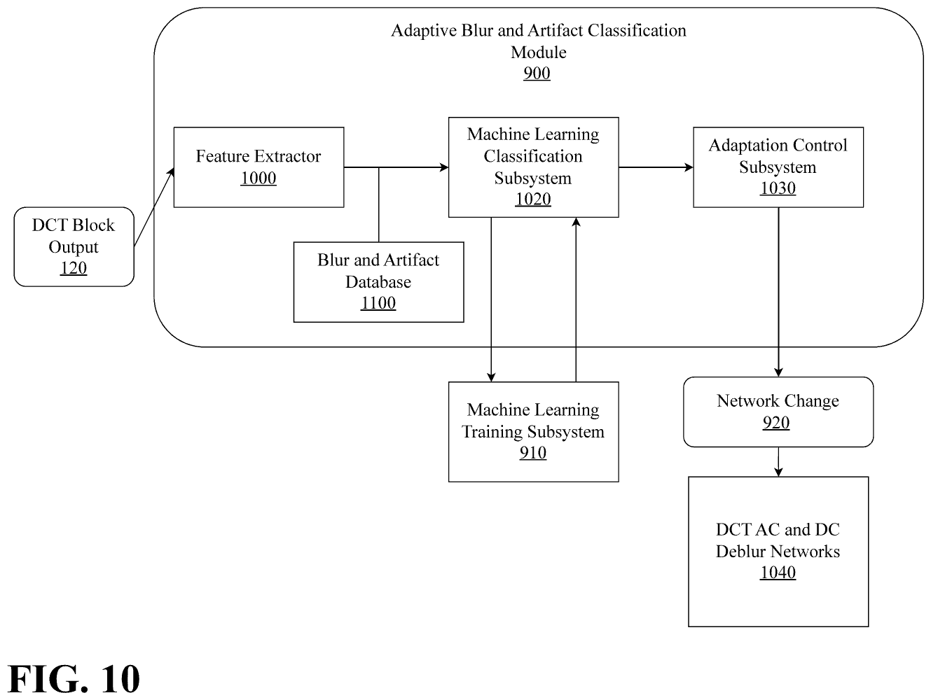

FIG. 10 is a block diagram illustrating an exemplary architecture for a subsystem of the system for adaptive real time discrete cosine transform image and video processing with convolutional neural network architecture, an adaptive blur and artifact classification module.

This module serves as the core of the system's adaptive capabilities, analyzing and categorizing image degradations to optimize the deblurring process. Incoming DCT output blocks 120 are first processed by a feature extractor 1000 within adaptive blur and artifact classification module 900.

This component receives the DCT block output 120 and performs a comprehensive analysis of the transformed image data. Feature extractor 1000 may employ various signal processing techniques to identify key characteristics that indicate different types of blur and artifacts. For example, it might analyze the distribution of frequency components to detect motion blur, examine edge sharpness to identify defocus blur, or look for regular patterns in the DCT coefficients that suggest compression artifacts. The extracted features form a compact yet informative representation of the image degradation, serving as input for the subsequent classification process.

This component receives the DCT block output 120 and performs a comprehensive analysis of the transformed image data. Feature extractor 1000 may employ various signal processing techniques to identify key characteristics that indicate different types of blur and artifacts. For example, it might analyze the distribution of frequency components to detect motion blur, examine edge sharpness to identify defocus blur, or look for regular patterns in the DCT coefficients that suggest compression artifacts. The extracted features form a compact yet informative representation of the image degradation, serving as input for the subsequent classification process.

A machine learning classification subsystem 1020 takes the extracted features and determines the types and severity of degradations present in the image. This subsystem utilizes a trained machine learning model, such as but not limited to a neural network or a random forest classifier, to categorize the degradations. The model might output probabilities for different blur types (e.g., 70% motion blur, 30% defocus blur) and artifact types (e.g., 80% blocking artifacts, 20% ringing artifacts), along with severity scores. This detailed classification allows for fine-tuned adaptation of the deblurring process.

An adaptation control subsystem 1030 acts as the decision-making component, translating the classification results into specific instructions for the DCT AC and DC deblur networks 1040. It uses predefined rules and learned patterns to determine the optimal processing parameters for each type and combination of degradations. For instance, if the classification indicates severe motion blur in the horizontal direction, the adaptation control subsystem might instruct the AC deblur network to increase its sensitivity to horizontal frequency components and adjust its filter strengths accordingly.

A blur and artifact database 1100 aids in training machine learning classification subsystem 1020 by storing a comprehensive collection of known degradation patterns, their characteristics, and effective treatment strategies. This database serves multiple purposes: it provides a baseline training corpus for training the machine learning classification subsystem 1020, helps in interpreting new or unusual degradation patterns, and stores successful adaptation strategies for future use. For example, if the system encounters a new combination of blur and compression artifacts, it can compare the extracted features with patterns in the database to make informed decisions about classification and adaptation.

A machine learning training subsystem 910 works in conjunction with the blur and artifact database to continuously improve the system's performance. It periodically retrains the classification model using accumulated data from processed images, user feedback, and new entries in the database. This ongoing learning process allows the system to adapt to new types of degradations and refine its classification accuracy over time. For instance, if users consistently report better results with certain adaptation strategies for specific degradation types, the training subsystem can adjust the classification model and adaptation rules accordingly.

A network change component 920 serves as the final link in this adaptive chain, implementing the instructions from the adaptation control subsystem. It dynamically adjusts the parameters, architectures, or processing flows of the DCT AC and DC deblur networks 1040 based on the adaptation decisions. This might involve switching between different pre-trained network configurations, adjusting layer weights, or modifying the network's attention mechanisms to focus on specific degradation types.

Together, these components form a sophisticated adaptive system capable of handling a wide range of image degradations in real-time. For example, when processing a video stream from a security camera, the system might encounter varying conditions throughout the day. During a clear afternoon, the feature extractor might identify minimal blur and compression artifacts. The classification subsystem would recognize this as a “clean” input, and the adaptation control would instruct the deblur networks to apply minimal processing, preserving the original image details. As night falls and the camera switches to low-light mode, the system might detect increased noise and motion blur. The adaptation control would then adjust the deblur networks to apply stronger noise reduction and motion compensation, optimizing the image quality for these challenging conditions.

This adaptive approach allows the system to maintain high image quality across diverse and changing conditions, making it suitable for a wide range of applications from consumer photography to professional video production and surveillance systems.

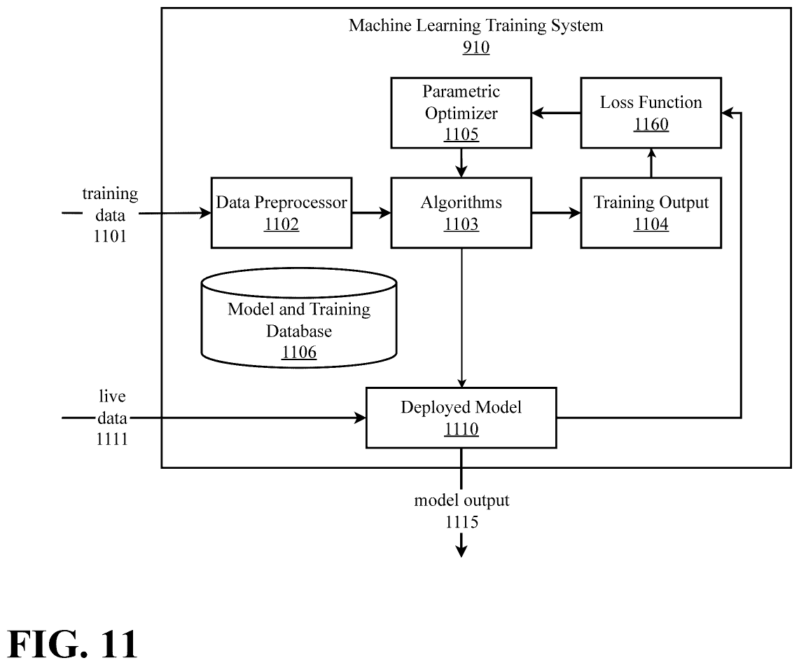

FIG. 11 is a block diagram illustrating an exemplary architecture for a subsystem of the system for adaptive real time discrete cosine transform image and video processing with convolutional neural network architecture, a machine learning training subsystem. According to an embodiment, the machine learning training subsystem 910 may comprise a model training stage comprising a data preprocessor 1102, one or more machine and/or deep learning algorithms 1103, training output 1104, and a parametric optimizer 1105, and a model deployment stage comprising a deployed and fully trained model 1110 configured to perform tasks described herein such as processing codewords through a large codeword model. The machine learning training subsystem 910 may be used to train and deploy an adaptive blur and artifact classification module that can identify what kinds of image or video blemishes are present in an input.

At the model training stage, a plurality of training data 1101 may be received by the machine learning training subsystem 910. Data preprocessor 1102 may receive the input data (e.g., image data, video data, blur data, artifact data) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 1102 may also be configured to create training dataset, a validation dataset, and a test set from the plurality of input data 1101. For example, a training dataset may comprise 80% of the preprocessed input data, the validation set 10%, and the test dataset may comprise the remaining 10% of the data. The preprocessed training dataset may be fed as input into one or more machine and/or deep learning algorithms 1103 to train a predictive model for object monitoring and detection.

During model training, training output 1104 is produced and used to measure the accuracy and usefulness of the predictive outputs. During this process a parametric optimizer 1105 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning training subsystem 910 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 1160 to measure the system's performance. The loss function 1160 compares the training outputs with an expected output and determined how the algorithm needs to be changed in order to improve the quality of the model output. During the training stage, all outputs may be passed through the loss function 1160 on a continuous loop until the algorithms 1103 are in a position where they can effectively be incorporated into a deployed model 1115.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 310 in a production environment making predictions based on live input data 1111 (e.g., image data, video data, blur data, artifact data). Further, model correlations and restorations made by deployed model can be used as feedback and applied to model training in the training stage, wherein the model is continuously learning over time using both training data and live data and predictions. A model and training database 1106 is present and configured to store training/test datasets and developed models. Database 1106 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 1103 may comprise a deep learning algorithm such as neural networks (e.g., recurrent, convolutional, long short-term memory networks, etc.).

In some implementations, the machine learning training subsystem 910 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 1106.

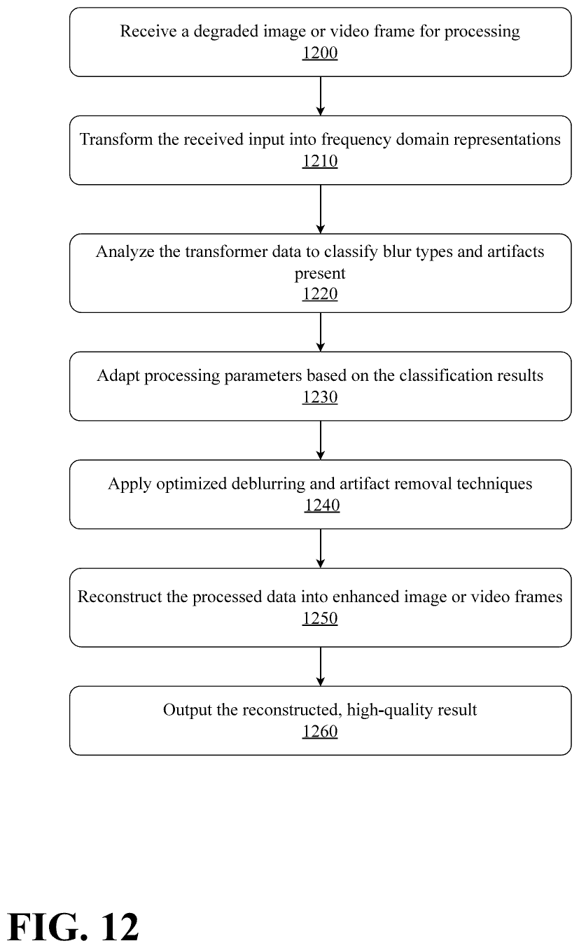

FIG. 12 is a flow diagram illustrating an exemplary method for adaptive real time discrete

cosine transform image and video processing with convolutional neural network architecture, according to an embodiment. In a first step 1200, a degraded image or video frame is received for processing. This step initiates the entire enhancement process by acquiring the raw input data. The degraded input could come from various sources such as a low-quality camera, compressed video stream, or an image affected by motion blur. This step provides the raw material that the subsequent steps will work to improve. The quality and characteristics of this input will significantly influence the processing required and the final output quality.

In a step 1210, the received input is transformed into frequency domain representations. This transformation, typically achieved through methods like the Discrete Cosine Transform (DCT), converts the spatial image data into a form that separates different frequency components. This step is vital because many types of image degradation, such as blur and compression artifacts, are more easily identified and addressed in the frequency domain. The transformation provides a different perspective on the image data, revealing patterns and characteristics that might not be apparent in the spatial domain. In a step 1220, the transformed data is analyzed to classify blur types and artifacts

present. This analytical step is where the system determines the specific types of degradation affecting the image or video frame. By examining the frequency domain representations, the system can identify characteristics indicative of different blur types (e.g., motion blur, defocus blur) and artifacts (e.g., compression blocking, ringing). This classification helps guide subsequent processing steps, allowing the system to tailor its approach to the specific degradations present in each input.

In a step 1230, processing parameters are adapted based on the classification results. This step represents the system's ability to dynamically adjust its processing strategy based on the analysis from the previous step. By fine-tuning parameters such as filter strengths, threshold values, or even selecting different processing algorithms, the system optimizes its approach for the specific degradations identified. This adaptive capability is key to achieving high-quality results across a wide range of input conditions.

In a step 1240, optimized deblurring and artifact removal techniques are applied. This is the core processing step where the actual image enhancement occurs. Using the adapted parameters from the previous step, the system applies specialized algorithms to counteract the identified blur and remove artifacts. This step might involve operations such as inverse filtering, regularized deconvolution for deblurring, or frequency domain manipulation for artifact removal. The optimization ensures that the processing is tailored to address the specific issues present in the current input.

In a step 1250, the processed data is reconstructed into enhanced image or video frames. This step involves converting the processed frequency domain data back into the spatial domain, resulting in a visually improved image or video frame. The reconstruction process ensures that the enhancements made in the frequency domain are correctly translated into visible improvements in the final output. This step helps produce a result that can be displayed or further processed in standard image or video formats.

In a step 1260, the reconstructed, high-quality result is output. This final step delivers the enhanced image or video frame for further use, whether it's for display, storage, or additional processing. The output represents the culmination of all previous steps, providing a significantly improved version of the original degraded input. This step allows for realizing the practical benefits of the entire process, whether it's improving visual quality for viewers, enhancing the accuracy of subsequent image analysis tasks, or preparing content for high-quality reproduction.

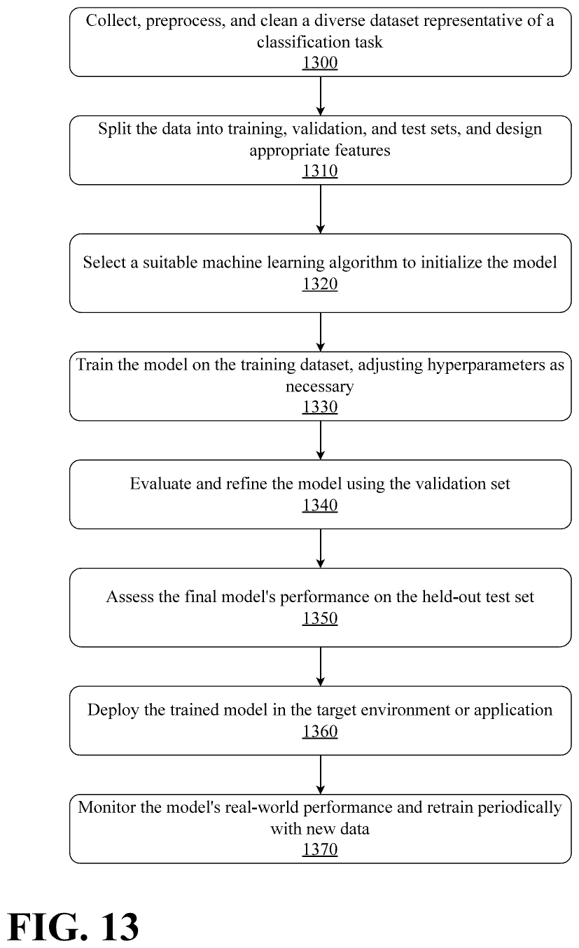

FIG. 13 is a flow diagram illustrating an exemplary method for training an adaptive blur and artifact classification module. In a first step 1300, a diverse dataset representative of the classification task is collected, preprocessed, and cleaned. This initial step forms the foundation of the entire machine learning process. Collection involves gathering a wide range of examples that cover all aspects of the classification problem. Preprocessing might include normalizing data, handling missing values, or encoding categorical variables. Cleaning involves removing or correcting erroneous data points. The quality and representativeness of this dataset significantly impact the model's ability to generalize and perform well on real-world data. A well-prepared dataset helps prevent issues like bias and overfitting in later stages.

In a step 1310, the data is split into training, validation, and test sets, and appropriate features are designed. This step ensures an unbiased evaluation of the model and for feature engineering. The training set, typically the largest portion, is used to teach the model. The validation set helps in tuning the model and preventing overfitting. The test set, kept completely separate, provides a final assessment of the model's performance. Feature design involves selecting or creating the most relevant attributes of the data for the classification task. This might include techniques like dimensionality reduction, feature scaling, or creating new features from existing ones. Proper data splitting and feature design lay the groundwork for effective model training and reliable performance estimation.

In a step 1320, a suitable machine learning algorithm is selected to initialize the model. This step involves choosing an algorithm that's appropriate for the specific classification task, considering factors like the nature of the data, the complexity of the problem, and computational resources. Options might include decision trees, support vector machines, neural networks, or ensemble methods like random forests. The choice of algorithm can significantly impact the model's performance, interpretability, and training time. Initializing the model sets the starting point for the training process.

In a step 1330, the model is trained on the training dataset, with hyperparameters adjusted as necessary. This is where the model learns to make predictions based on the input features. The training process involves exposing the model to the training data repeatedly, allowing it to adjust its internal parameters to minimize prediction errors. Hyperparameter adjustment, which might involve techniques like grid search or random search, helps optimize the model's learning process.

In a step 1340, the model is evaluated and refined using the validation set. This step serves as a checkpoint to assess how well the model generalizes to data it hasn't been trained on. The validation set helps detect overfitting, where the model performs well on training data but poorly on new data. Based on the validation results, the model can be refined by adjusting hyperparameters, modifying the model architecture, or even revisiting the feature design. This iterative process of evaluation and refinement is key to developing a robust and accurate classifier.

In a step 1350, the final model's performance is assessed on the held-out test set. This step provides an unbiased estimate of how well the model will perform on completely new, unseen data. The test set, which has been kept separate throughout the development process, simulates real-world application of the model. Performance metrics such as accuracy, precision, recall, and FI score are typically used to quantify the model's effectiveness.

In a step 1360, the trained model is deployed in the target environment or application. This step transitions the model from development to practical use. Deployment might involve integrating the model into a larger software system, setting up necessary infrastructure for real-time predictions, or packaging the model for distribution. Considerations during deployment include scalability, latency, and compatibility with existing systems.

In a step 1370, the model's real-world performance is monitored, and it is retrained periodically with new data. This ongoing step ensures the model remains effective over time. Real-world data may differ from the training data or change over time (concept drift), affecting the model's performance. Monitoring helps detect these issues early. Periodic retraining with new data allows the model to adapt to changing patterns or new categories in the classification task. This step is essential for maintaining the model's relevance and accuracy in dynamic real-world environments.

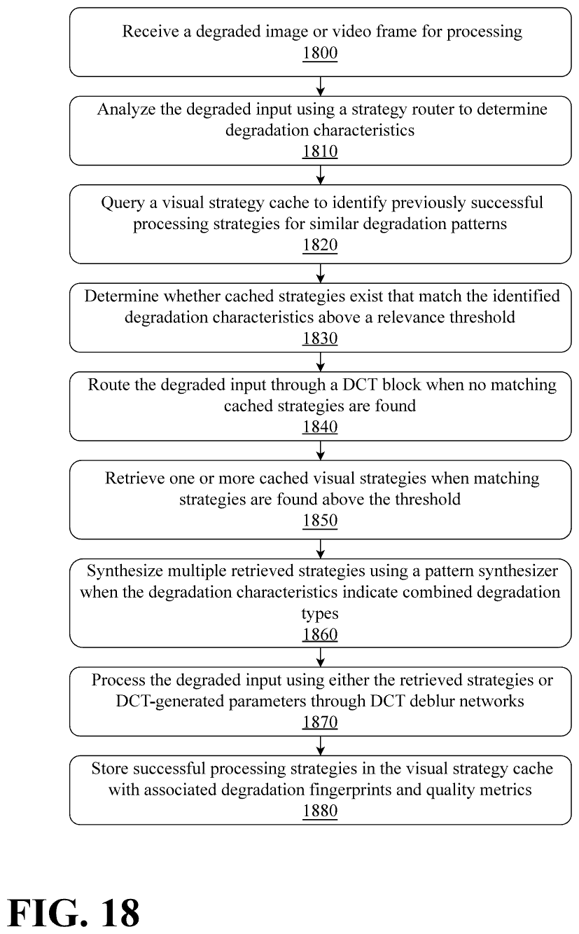

FIG. 18 is a flow diagram illustrating an exemplary method for adaptive real time discrete cosine transform image and video processing with convolutional neural network architecture using visual strategy caching. In a first step 1800, a degraded image or video frame is received for processing. This initial step involves acquiring image data that contains various forms of degradation such as motion blur, defocus blur, compression artifacts, or noise. The degraded image may come from various sources including digital cameras, video streams, scanned documents, or transmitted media. The reception process includes buffering the image data in appropriate formats and preparing it for subsequent analysis.

In a step 1810, the degraded input is analyzed using a strategy router to determine degradation characteristics. This analysis involves extracting multiple features from the image that indicate the type and severity of degradation present. Feature extraction may include computing frequency domain statistics to identify blur patterns, analyzing edge profiles to detect motion direction and magnitude, measuring noise distributions across different image regions, and identifying compression artifact signatures such as blocking or ringing. The analysis produces a comprehensive degradation profile that characterizes the specific quality issues affecting the image.

In a step 1820, a visual strategy cache is queried to identify previously successful processing strategies for similar degradation patterns. The query process involves converting the degradation profile into searchable parameters that can be matched against stored strategies. This may involve computing similarity metrics between the current degradation characteristics and those associated with cached strategies, using techniques such as vector distance calculations, histogram comparisons, or pattern matching algorithms. The query returns a set of candidate strategies ranked by their relevance to the current degradation profile.

In a step 1830, a determination is made whether cached strategies exist that match the identified degradation characteristics above a relevance threshold. This decision process involves comparing similarity scores or confidence metrics against predetermined thresholds that indicate sufficient match quality. The threshold may be adaptive based on factors such as the complexity of the degradation, the criticality of the processing task, or historical success rates. The determination results in a binary decision that directs subsequent processing along one of two paths.

In a step 1840, the degraded input is routed through a DCT block when no matching cached strategies are found. This path represents traditional processing where the image undergoes discrete cosine transformation to convert it from spatial to frequency domain. The transformation typically employs blockwise processing, such as 4×4 or 8×8 blocks, to decompose the image into multiple frequency components. This step is executed when the degradation pattern is novel or when cached strategies do not meet the relevance threshold.

In a step 1850, one or more cached visual strategies are retrieved when matching strategies are found above the threshold. The retrieval process involves accessing the stored strategy data which includes processing parameters, network configurations, and transformation coefficients that previously succeeded in correcting similar degradations. Multiple strategies may be retrieved when the degradation profile indicates complex or compound degradation types that might benefit from combined approaches.

In a step 1860, multiple retrieved strategies are synthesized using a pattern synthesizer when the degradation characteristics indicate combined degradation types. Synthesis involves intelligently merging different strategies to create a unified approach that addresses all identified degradation aspects. This may include calculating weighted combinations of parameters where weights are determined by the relative severity of each degradation type, resolving conflicts between strategies that might specify contradictory operations, and optimizing the combined strategy to eliminate redundancies and improve efficiency. The synthesis produces a cohesive processing strategy that leverages the strengths of multiple cached approaches.

In a step 1870, the degraded input is processed using either the retrieved strategies or DCT-generated parameters through DCT deblur networks. When using retrieved strategies, the pre-computed parameters are applied directly to configure the deblur networks, bypassing the need for frequency analysis. When using DCT-generated parameters, the frequency domain data from the DCT transformation guides the network configuration. The processing involves applying learned deblurring operations specific to different frequency bands, with separate handling of low-frequency components that represent image structure and high-frequency components that represent details and edges.

In a step 1880, successful processing strategies are stored in the visual strategy cache with associated degradation fingerprints and quality metrics. Storage involves evaluating the effectiveness of the processing through quality measurements such as peak signal-to-noise ratio improvements, structural similarity indices, or perceptual quality scores. When these metrics indicate successful correction, the processing parameters are packaged with the degradation profile that triggered their use. This creates a new cached entry that can accelerate future processing of similar images, continuously expanding the knowledge base of effective correction strategies. The storage process includes indexing the new strategy for efficient retrieval and potentially triggering cache maintenance operations such as consolidation of similar strategies or removal of obsolete entries.

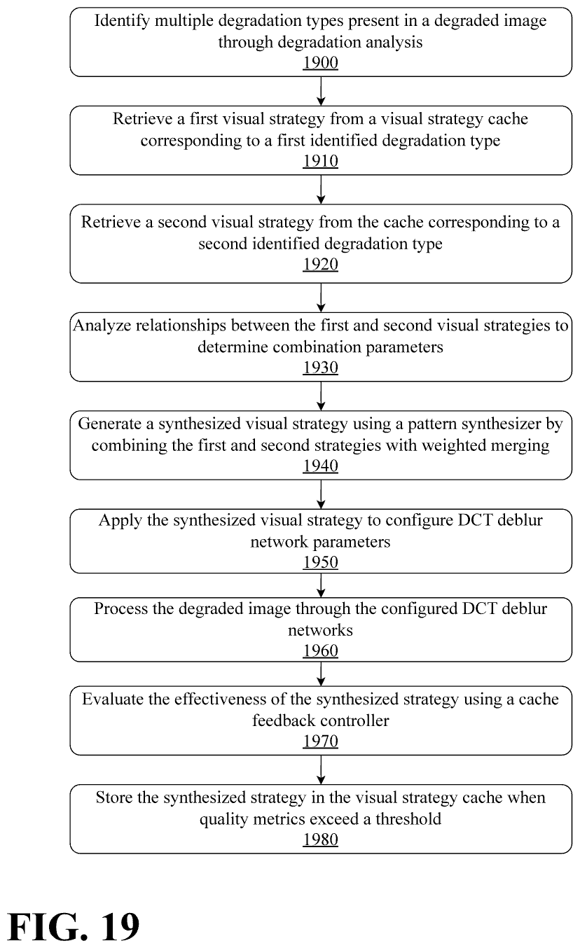

FIG. 19 is a flow diagram illustrating an exemplary method for visual strategy synthesis and application in adaptive image processing. In a first step 1900, multiple degradation types present in a degraded image are identified through degradation analysis. This identification process involves comprehensive examination of the image to detect and classify various forms of quality degradation that may be affecting different aspects or regions of the image. The analysis employs multiple detection techniques including frequency spectrum analysis to identify characteristic patterns of different blur types, statistical analysis of pixel distributions to detect noise signatures, and structural analysis to identify compression artifacts or optical distortions. Each identified degradation type is characterized by its specific attributes such as blur direction and magnitude for motion blur, spread function parameters for defocus blur, or block size and severity for compression artifacts.

In a step 1910, a first visual strategy is retrieved from a visual strategy cache corresponding to a first identified degradation type. The retrieval process involves matching the specific characteristics of the first degradation type against indexed entries in the cache to find the most appropriate correction strategy. The retrieved strategy contains comprehensive processing information including transformation parameters, filter coefficients, neural network configurations, and processing sequences that have previously proven effective for similar degradation patterns. The strategy may also include metadata about its historical performance and optimal application conditions.

In a step 1920, a second visual strategy is retrieved from the cache corresponding to a second identified degradation type. This retrieval follows a similar process to the first but targets a different degradation characteristic identified in the image. For example, if the first strategy addresses motion blur, the second might target compression artifacts or noise. The independent retrieval of multiple strategies allows for specialized handling of each degradation type with parameters optimized for that specific problem.

In a step 1930, relationships between the first and second visual strategies are analyzed to determine combination parameters. This analysis examines potential interactions between the two strategies to identify areas of compatibility and conflict. The analysis considers whether the strategies operate on overlapping frequency bands where interference might occur, whether the processing operations of one strategy might amplify or diminish the effects of the other, and whether there are shared operations that could be consolidated for efficiency. The analysis produces combination parameters that specify how the strategies should be merged, including relative weights, processing order, and conflict resolution rules.

In a step 1940, a synthesized visual strategy is generated using a pattern synthesizer by combining the first and second strategies with weighted merging. The synthesis process applies the combination parameters determined in the previous step to create a unified processing approach. Weighted merging involves calculating appropriate contribution levels for each strategy based on factors such as the relative severity of each degradation type, the confidence in each strategy's effectiveness, and the potential for interaction effects. The synthesis may employ various merging techniques including linear combination of parameters for independent operations, sequential application where order dependencies exist, or parallel processing for operations affecting different frequency bands. The result is a cohesive strategy that addresses multiple degradation types simultaneously.

In a step 1950, the synthesized visual strategy is applied to configure DCT deblur network parameters. This application involves translating the high-level strategy specifications into specific configuration settings for the processing networks. Configuration includes setting filter kernels for convolution operations based on the synthesized blur correction parameters, adjusting activation thresholds and weight matrices in neural network layers, establishing processing sequences that optimize the order of operations, and allocating computational resources appropriately between different processing channels. The configuration ensures that the networks are optimally prepared to process the specific combination of degradations present in the image.

In a step 1960, the degraded image is processed through the configured DCT deblur networks. The processing applies the synthesized strategy's operations to the image data, with different network channels handling different frequency components according to the configuration. Low-frequency channels process overall image structure while high-frequency channels address fine details and edges. The synthesized strategy guides how these channels interact and combine their outputs to produce a coherent corrected image that addresses all identified degradation types.

In a step 1970, the effectiveness of the synthesized strategy is evaluated using a cache feedback controller. This evaluation measures the quality improvement achieved by the synthesized strategy through various metrics including objective measures such as signal-to-noise ratio improvements and structural similarity indices, perceptual quality assessments that consider human visual system characteristics, and specific degradation reduction metrics that quantify how well each identified problem was addressed. The evaluation also considers computational efficiency metrics to ensure the synthesized strategy provides good performance characteristics.

In a step 1980, the synthesized strategy is stored in the visual strategy cache when quality metrics exceed a threshold. Storage involves packaging the synthesized strategy with its associated metadata including the combination of degradation types it addresses, the quality improvements it achieved, and the synthesis parameters used to create it. This stored synthesized strategy becomes available for future use when similar combinations of degradation are encountered, eliminating the need to re-synthesize the same combination. The threshold for storage ensures that only effective synthesized strategies are retained, maintaining the quality and reliability of the cache contents. The storage process may also trigger cache optimization operations such as identifying and consolidating similar synthesized strategies or updating relationship mappings between related strategies.

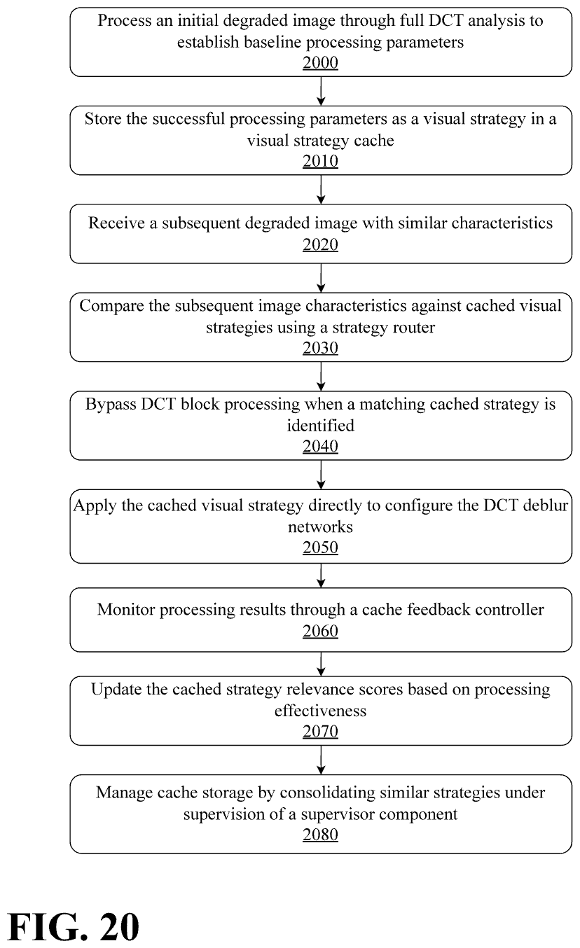

FIG. 20 is a flow diagram illustrating an exemplary method for cache-based visual processing optimization. In a first step 2000, an initial degraded image is processed through full DCT analysis to establish baseline processing parameters. This comprehensive analysis involves performing discrete cosine transformation on the image to decompose it into frequency components, analyzing the frequency domain representation to identify specific degradation characteristics, and determining optimal correction parameters through iterative refinement. The full DCT analysis generates detailed processing parameters including transformation coefficients, filter specifications, and network configurations that successfully address the identified degradations. This initial processing serves as a learning opportunity to develop effective strategies that can be reused for similar images.

In a step 2010, the successful processing parameters are stored as a visual strategy in a visual strategy cache. Storage involves packaging the parameters with descriptive metadata that characterizes the degradation pattern they address, including degradation type classifications, severity metrics, and spatial distribution information. The strategy is indexed using multiple attributes to enable efficient retrieval, such as degradation fingerprints computed from image characteristics, quality improvement metrics achieved by the strategy, and computational complexity indicators. The stored strategy represents a proven solution that can accelerate future processing of images with similar degradation patterns.

In a step 2020, a subsequent degraded image with similar characteristics is received. This subsequent image may come from the same source as the initial image, such as consecutive frames in a video sequence, or from different sources that exhibit similar degradation patterns due to common capture conditions or processing pipelines. The reception process prepares the image for analysis while maintaining any relevant contextual information that might indicate similarity to previously processed images.

In a step 2030, the subsequent image characteristics are compared against cached visual

strategies using a strategy router. The comparison process involves extracting characteristic features from the subsequent image using the same analysis techniques applied to the initial image, computing similarity metrics between these features and those stored with cached strategies, and ranking cached strategies based on their relevance to the current image. The strategy router employs efficient search algorithms to quickly identify potentially matching strategies from what may be a large cache of stored solutions.

In a step 2040, DCT block processing is bypassed when a matching cached strategy is identified. This bypass decision occurs when the similarity metrics exceed predetermined thresholds that indicate high confidence in the cached strategy's applicability. By avoiding the computationally intensive DCT transformation and analysis, significant processing time and resources are saved. The bypass path represents a key efficiency gain enabled by the caching mechanism, allowing rapid processing of images that match previously encountered patterns.

In a step 2050, the cached visual strategy is applied directly to configure the DCT deblur networks. Direct application involves retrieving the complete parameter set from the cached strategy, configuring network layers with the stored weights and thresholds, setting processing sequences and data flow paths, and preparing any auxiliary structures needed for the specific correction approach. This pre-configuration eliminates the need for the networks to learn or derive these parameters through analysis, enabling immediate processing with proven settings.

In a step 2060, processing results are monitored through a cache feedback controller. Monitoring involves measuring the quality of the processed output using various metrics, comparing actual results against expected outcomes based on the cached strategy's historical performance, and detecting any anomalies or degradation in effectiveness that might indicate changes in image characteristics or strategy deterioration. The feedback controller provides continuous quality assurance to ensure cached strategies maintain their effectiveness over time.

In a step 2070, the cached strategy relevance scores are updated based on processing effectiveness. Score updates reflect the observed performance when applying the strategy to new images, with successful applications increasing the relevance score and unsuccessful ones decreasing it. The scoring mechanism may employ weighted averaging that gives more importance to recent applications, ensuring scores reflect current effectiveness rather than historical performance. These dynamic scores influence future strategy selection decisions and help identify strategies that may need updating or removal.

In a step 2080, cache storage is managed by consolidating similar strategies under supervision of a supervisor component. Cache management involves identifying groups of strategies that address similar degradation patterns with minor variations, analyzing the relationships and overlaps between these similar strategies, and creating consolidated strategies that capture the common effective elements while maintaining necessary variations. The consolidation process may involve merging parameter sets using statistical techniques to find optimal representative values, creating parameterized strategies that can adapt to variations within a degradation category, or establishing hierarchical relationships where general strategies can be specialized as needed. This management ensures the cache remains efficient and organized while preventing unlimited growth from accumulating many nearly-identical strategies. The supervisor component ensures consolidation preserves strategy effectiveness while improving cache efficiency and retrieval speed.

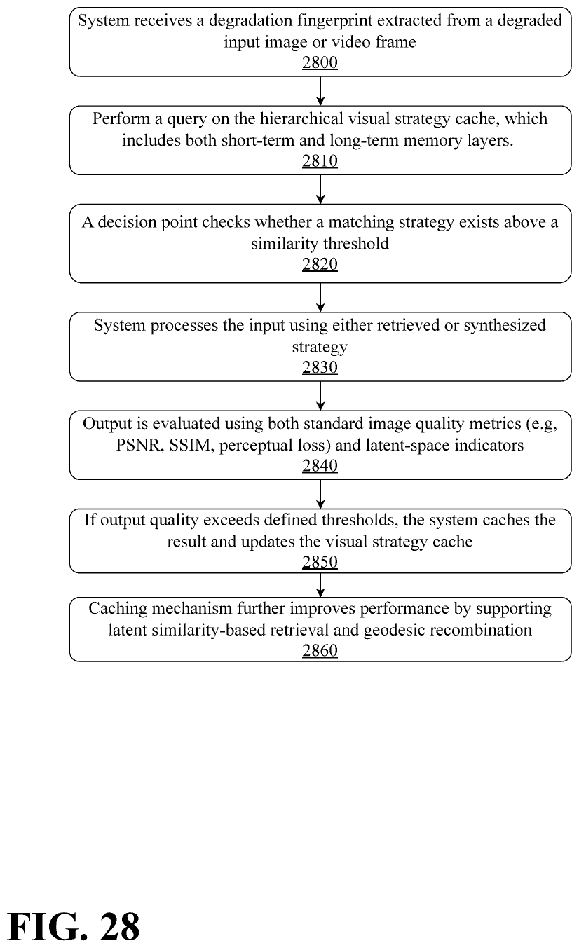

FIG. 28 is a flow diagram representing an exemplary method for adaptive image and video processing within a system that implements a hierarchical visual strategy cache integrated into a Persistent Cognitive Machine (PCM) architecture. This method enables intelligent selection, adaptation, and learning of image enhancement strategies via a closed-loop process involving geodesic memory access, strategy synthesis, output evaluation, and memory promotion. Over time, the system evolves to support experience-driven visual cognition and strategic generalization.

In the first step 2800, the system receives a degradation fingerprint extracted from a degraded input image or video frame. The degradation fingerprint represents a structured description of observed visual defects, such as motion blur, defocus or compression artifacts. This fingerprint is embedded into a Lorentzian latent space and serves as a query vector for strategy retrieval.

In step 2810, the system performs a query on the hierarchical visual strategy cache, which includes both short-term and long-term memory layers. Cached strategies are encoded as latent geodesic trajectories, each tagged with symbolic anchors and prior quality metrics. The system evaluates latent similarity between the current fingerprint and existing trajectories to determine whether a matching strategy is available.

In step 2820, A decision point checks whether a matching strategy exists above a similarity threshold. If no match is found, the system routes the input through a DCT Deblur network using default or baseline parameters. If a match is found, the system proceeds to retrieve the strategy for direct application. In some cases—such as compound or novel degradations—the system invokes a pattern synthesizer to interpolate multiple partially matching strategies, generating a new latent geodesic strategy tailored to the input conditions.

In step 2830, the system processes the input using either the retrieved or synthesized strategy. The DCT Deblur network applies transform-domain neural enhancement using AC and DC channel decomposition. The processing logic and network parameters are determined by the latent path associated with the selected or synthesized strategy.

In step 2840, The output is evaluated using both standard image quality metrics (e.g., PSNR, SSIM, perceptual loss) and latent-space indicators, including compression pressure, which reflects the semantic density or cognitive saliency of the latent representation. These metrics provide feedback to the strategy router and cache management components.

In a step 2850, If the output quality exceeds defined thresholds, the system caches the result and updates the visual strategy cache. The new or refined strategy is stored as a latent trajectory, indexed with its degradation fingerprint, symbolic tags, quality metrics, and synthesis metadata. This caching step improves the system's ability to address future degradation patterns with faster, more targeted retrieval.

In a step 2860, The caching mechanism further improves performance by supporting latent similarity-based retrieval and geodesic recombination. Unlike systems that rely on exact symbolic matches, this architecture allows retrieval of near-matching latent paths, enabling reuse even when the current input only partially resembles previous degradations. As a result, the system expands its strategic recall capacity and reduces computational overhead.

When no strong match is available, the system learns by synthesizing new latent trajectories from partially relevant strategies. The synthesized trajectory is archived with its quality metadata, thereby densifying the strategic manifold and improving future hit rates.

### Exemplary Computing Environment

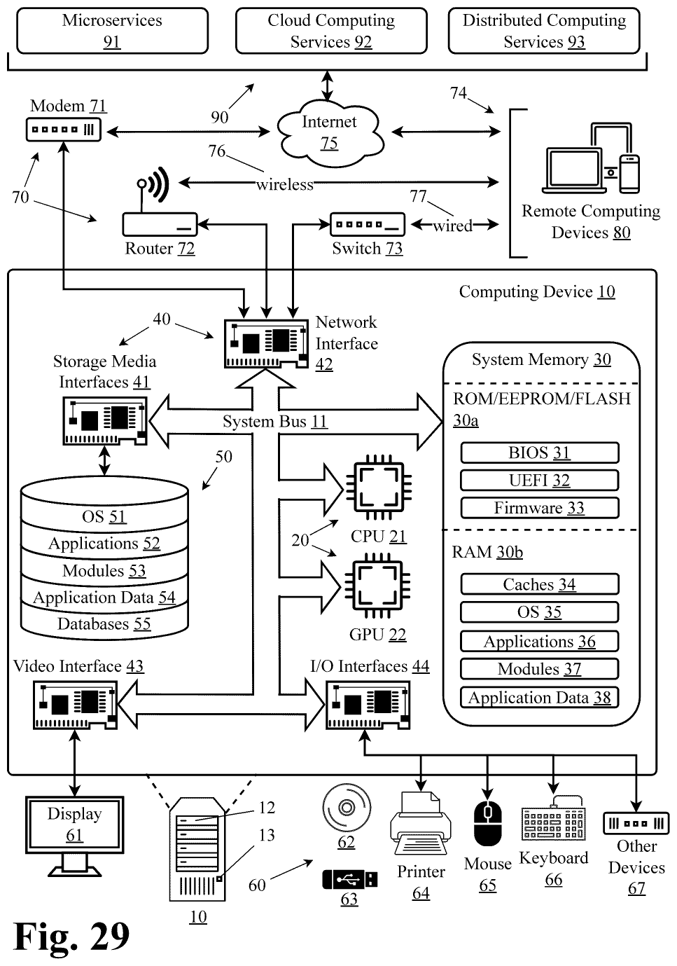

FIG. 29 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable

computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system implementing a persistent cognitive machine (PCM) architecture for adaptive image and video processing, the computer system comprising:
a hardware memory, wherein the computer system is configured to execute software instructions stored on non-transitory machine-readable storage media that:
receive a degraded input media for processing;
extract a degraded fingerprint from the degraded input media;
analyze the degraded input media using a strategy router to determine degradation characteristics;
query a PCM-based visual strategy cache that stores previously successful visual processing strategies as latent geodesic trajectories indexed by degradation patterns, wherein the cache implements unified cognitive memory principles across multiple processing domains;
determine whether one or more cached strategies match the degradation characteristics above a predetermined relevance threshold of at least 0.85 cosine similarity;
when no matching cached strategy is found, route the degraded input through a processing block to generate processed representations;
when one or more cached strategies are found, retrieve the matching strategy or strategies;
a new strategy using a pattern synthesizer that combines multiple cached strategies through weighted geodesic interpolation when the degradation fingerprint indicates complex degradation types;
process the degraded input using either the retrieved strategies or processing-block-generated parameters through processing networks;
evaluate the effectiveness of the processed output using a feedback controller; and
store newly successful visual strategies in the PCM-based visual strategy cache with associated data.

2. The computer system of claim 1, wherein the processing block comprises a discrete cosine transform (DCT) block.

3. The computer system of claim 2, wherein the DCT block employs a 4×4 discrete cosine transform function.

4. The computer system of claim 1, wherein the processing networks comprise convolutional neural network (CNN) architectures.

5. The computer system of claim 1, wherein the processing networks comprise separate AC and DC processing channels for handling high-frequency and low-frequency components respectively.

6. The computer system of claim 1, wherein the visual strategy cache comprises a hierarchical memory structure including short-term memory and long-term memory components.

7. The computer system of claim 1, wherein the pattern synthesizer comprises a weight calculator and a strategy merger for combining multiple cached strategies through weighted geodesic averaging in the Lorentzian latent space.

8. The computer system of claim 1, wherein the feedback controller computes quality metrics including peak signal-to-noise ratio (PSNR) and structural similarity index (SSIM).

9. The computer system of claim 1, wherein the degradation characteristics include one or more of motion blur, defocus blur, compression artifacts, and noise patterns.

10. The computer system of claim 1, wherein the visual strategies are encoded as discrete latent geodesic trajectories in a 512-dimensional Lorentzian manifold with metric tensor G_μv=diag(−1, 1, 1, . . . , 1), each trajectory comprising a sequence of waypoints {z₁, z₂, . . . , zₙ} connected by geodesic curves γ(t)=cosh(td)z₁+sinh(td)v, with associated symbolic anchors automatically attached to waypoints exhibiting high semantic curvature κ(t)>0.1.

11. A method for adaptive image and video processing, comprising the steps of:
receiving a degraded input media for processing;
extracting a degraded fingerprint from the degraded input;
analyzing the degraded input using a strategy router to determine degradation characteristics;
querying a PCM-based visual strategy cache that stores previously successful visual processing strategies as latent geodesic trajectories with symbolic anchors in a unified cognitive memory framework;
determining whether one or more cached strategies match the degradation fingerprint based on geodesic distance similarity above a relevance threshold of at least 0.85 cosine similarity;
when no matching cached strategy is found, routing the degraded input through a processing block to generate processed representations;
when one or more cached strategies are found, retrieving the matching strategy or strategies;
synthesizing a new strategy using a pattern synthesizer when the degradation fingerprint indicates complex degradation types;
processing the degraded input using either the retrieved strategies or processing-block-generated parameters through processing networks;
evaluating the effectiveness of the processed output using a feedback controller; and
storing newly successful visual strategies in the PCM-based visual strategy cache with associated data cache.

12. The method of claim 11, wherein the processing block comprises a discrete cosine transform (DCT) block.

13. The method of claim 11, wherein the DCT block employs a 4×4 discrete cosine transform function.

14. The method of claim 11, wherein the DCT block employs a wavelet transform function to process the degraded input.

15. The method of claim 11, wherein the processing networks comprise convolutional neural network (CNN) architectures.

16. The method of claim 11, wherein the processing networks comprise separate AC and DC processing channels for handling high-frequency and low-frequency components respectively.

17. The method of claim 11, wherein the visual strategy cache comprises a hierarchical memory structure including short-term memory and long-term memory components.

18. The method of claim 11, wherein the pattern synthesizer comprises a weight calculator and a strategy merger for combining multiple cached strategies.

19. The method of claim 11, wherein the feedback controller computes quality metrics including peak signal-to-noise ratio (PSNR) and structural similarity index (SSIM).

20. The method of claim 11, wherein the degradation characteristics include one or more of motion blur, defocus blur, compression artifacts, and noise patterns.
